(19) United States
(12) Patent Application Publication
(10) Pub. No.: US 2011/0101085 A1
(43) Pub. Date: May 5, 2011

(54) REMOTE CODE READER SYSTEM, LOCAL CODE READER, HOST COMPUTER, ADVERTISEMENT SUPPORT METHOD, INPUT DEVICE, AND RECORDING MEDIUM

(76) Inventor: Katsuya Nakagawa, Shiga (JP)

(21) Appl. No.: 12/160,018

(22) PCT Filed: Dec. 28, 2006
(86) PCT No.: PCT/JP2006/326408

§ 371 Date: Dec. 29, 2010

(30) Foreign Application Priority Data
Jan. 3, 2006 (JP) 2006-000002
Jun. 27, 2006 (JP) 2006-176557

(51) Int. Cl. G06F 17/00

(52) U.S. Cl. 235/375

(57) ABSTRACT

A number of various and arbitrary local barcode readers 7 read barcodes 11 and transmit the barcodes 11 to a host computer 1 through communication terminals 5f or 5m corresponding thereto and the Internet 3. The host computer 1 performs a predetermined process by the use of the barcode 11 which is transmitted by the local barcode reader 7. The host computer 1 transmits HTML information to the terminal 5 for showing a display on the terminal 5. The terminal 5 can show a various display in accordance with the HTML information which is received.

### TECHNICAL FIELD

The present invention relates to a remote code reader system and the related arts for collecting and processing codes (for example, barcodes) which are transmitted from a local code reader.

### BACKGROUND ART

Patent Document 1 (Japanese Patent Published Application No. Hei 6-12573) discloses a POS (Point Of Sale) system. This POS system includes a POS terminal and a store controller. In accordance with this POS system, the POS terminal includes a scanner with which a barcode printed on a commodity product is scanned and transmitted to the store controller as a barcode symbol scan signal through an internal communication line. The store controller includes an arithmetic processing unit which searches commodity master data stored in a storage unit in which unit prices and names of commodities are stored in advance, and returns the search result to the POS terminal. The POS terminal then calculates the amount of sales, and outputs a receipt.

Patent Document 2 (Japanese Patent Published Application No. 2003-337902) discloses a commodity information providing system. In accordance with this commodity information providing system, a mobile communication terminal scans a barcode attached to a commodity product by a barcode scanning device, and transmits the scan data to the commodity information providing server through a network. When receiving the scan data, the commodity information providing server reads information about the commodity corresponding thereto from a commodity information database, and transmits the information about the commodity to the mobile communication terminal. By this procedure, the user of the mobile communication terminal can acquire a variety of information about the commodity.

Patent Document 3 (Japanese Patent Published Application No. 2001-306624) discloses an information gathering system making use of a barcode reader. This barcode reader adds identification data for specifying the barcode reader to the barcode data, and transmits the barcode data to a PC. The PC then transmits the data to a host computer through a communication network.

Generally speaking, the POS system is installed in each store. Accordingly, the POS terminal of a certain store does not access the store controller of another store for acquiring price information, calculating the amount of sales and outputting a receipt, even if these stores are belonging to the same company. Needless to say, this is also true between stores belonging to different companies. In this way, the POS system is installed as a closed network in each store. Of course, it is common to transfer the data accumulated by the store controllers of the respective stores belonging to the same company periodically to a host computer at the central office of this company for the purpose of analyzing and managing the data as accumulated.

In accordance with the commodity information providing system as described above, the user operates the terminal and accesses the server to transmit the barcode which is scanned by the barcode reader to this server. The user can thereby receive information about the commodity on which the transmitted barcode has been attached, from the server. This system is a server client system which is built with a mobile communication terminal serving as a client terminal. Accordingly, in this system, while the terminal serving as a client terminal has an important role, the barcode reader is nothing more than an input device connected to the client terminal.

In accordance with the information gathering system as described above, the identification data of the barcode reader has an important role, and is given to the host computer together with the barcode data. The host computer manages the personal information of the user in association with the identification data of the barcode reader. Accordingly, this system can know which user transmits the barcode reader. In other words, in this system, it is assumed that the host computer identifies the user as the terminal which has transmitted the barcode data.

It is an object of the present invention to provide a remote code leader system and the related techniques, with which arbitrary cords can be globally collected and processed by connecting arbitrary unspecified local code leader with a host computer through the Internet and an arbitrary communication terminal connected therewith.

### DISCLOSURE OF THE INVENTION

In accordance with a first aspect of the present invention, a remote code leader system comprises: a plurality of unspecified local code leaders (for example, local barcode readers) each of which is capable of reading a code (for example, barcode) and connected with a communication terminal which is provided corresponding to the each local code leader and connectable with the Internet; and a host computer operable to receive a plurality of the codes transmitted from the plurality of said local code leaders respectively, wherein each of said local code leaders includes a transmission unit which transmits the code as read to said host computer through the communication terminal corresponding thereto and the Internet, and wherein said host computer includes a processing unit which performs a predetermined process by the use of the code as transmitted from said local code leader.

In accordance with this structure, a plurality of arbitrary unspecified local code leaders are connected with the host computer through the Internet and the plurality of arbitrary communication terminals connected thereto. In other words, a plurality of various and arbitrary unspecified local code readers are connected to the host computer, regardless of the individuals and enterprises. Accordingly, the host computer can globally collect and process a number of various and arbitrary codes. Also, unspecified local code readers are connected to the host computer. In other words, the host computer need not identify each local code reader, and is not mainly provided for the purpose of identifying which user transmits a code. Of course, in the case of the present invention, while the host computer can perform processing by identifying which user transmits a code, it is possible for the user to perform user registration through his own communication terminal.

In accordance with a second aspect of the present invention, a remote code leader system comprises: a plurality of local code leaders (for example, local barcode reader) each of which is capable of reading a code (for example, barcode) and connected with a communication terminal which is provided corresponding to the each local code leader and connectable with the Internet; and a host computer operable to receive a plurality of the codes transmitted from the plurality of said local code leaders respectively, wherein each of said local code leaders includes a transmission unit which transmits the code as read to said host computer through the communication terminal corresponding thereto and the Internet, wherein said host computer includes a processing unit which performs a predetermined process by the use of the code as transmitted from said local code leader, and wherein the code is transmitted to said host computer by the communication terminal through the Internet in response to transmission of the code from the transmission unit.

In accordance with this structure, a plurality of arbitrary local code leaders are connected with the host computer through the Internet and a plurality of arbitrary communication terminals connected thereto. In other words, a plurality of various and arbitrary local code readers are connected to the host computer, regardless of the individuals and enterprises. Accordingly, the host computer can globally collect and process a number of various and arbitrary codes. In addition, since the operation of scanning a code serves as a trigger, the user of the communication terminal can transmit the code to the host computer only by reading the code through a local code reader without need for any particular operation of the terminal. That is to say, it is possible to improve the convenience of the user.

In the case of the remote code leader systems according to the first and second aspects as described above, the processing unit transmits, to the communication terminal, information for showing a display on the communication terminal in accordance with the predetermined process which is performed.

By this configuration, in response to the code transmitted to the host computer, the user of the communication terminal can receive a service which is provided by the host computer in correspondence with the predetermined process.

In accordance with a third aspect of the present invention, a remote code leader system comprises: a plurality of local code leaders (for example, local barcode reader) each of which is capable of reading a code (for example, barcode) and connected with a communication terminal which is provided corresponding to the each local code leader and connectable with the Internet; and a host computer operable to receive a plurality of the codes transmitted from the plurality of said local code leaders respectively, wherein each of said local code leaders includes a transmission unit which transmits the code as read to said host computer through the communication terminal corresponding thereto and the Internet, and said host computer comprises: a receiver unit operable to receive the codes which are transmitted from said local code leaders; a classification unit operable to classify each of the received codes into one of a plurality of groups; and a processing unit operable to perform, by the use of each of the received codes, a process corresponding to the group to which the each of the received codes belongs.

In accordance with this structure, a plurality of arbitrary local code leaders are connected with the host computer through the Internet and a plurality of arbitrary communication terminals connected thereto. In other words, a plurality of various and arbitrary local code readers are connected to the host computer, regardless of the individuals and enterprises. Accordingly, the host computer can globally collect a number of various and arbitrary codes. The host computer performs a process in accordance with the group to which the code belongs, and transmits to the communication terminal the content which is provided corresponding to this group and corresponding to the code. Thereby, the communication terminal can display a variety items of content in accordance with the barcodes. In other words, in response to the sending of the code to the host computer, the user of the local code reader can receive a variety of services which are provided by the host computer in correspondence with this code. In this case, as long as the user possesses at least one local code reader, he can receive a variety of different services. In addition to this, only by scanning a code, the user of the local code reader can readily receive the service and content provided corresponding to this code with no need to search sites for receiving the desired service and content.

In the case of the remote code leader systems according to the first through third aspects as described above, the transmission unit outputs, to said communication terminal, the code, address information (for example, URL) of said host computer and a command for instructing said communication terminal to transmit the code to said host computer.

In accordance with this configuration, the local code reader outputs the address information of the host computer and the command to the communication terminal together with the code. Because of this, software need not be installed in the communication terminal for transmitting the code to the host computer, and thereby it is possible to further improve the convenience of the user.

In accordance with a fourth aspect of the present invention, a remote code leader system comprises: a plurality of local code leaders (for example, local barcode reader) each of which is capable of reading a code (for example, barcode) and connected with a communication terminal which is provided corresponding to the each local code leader and connectable with the Internet; and a host computer operable to receive a plurality of the codes transmitted from the plurality of said local code leaders respectively, wherein each of said local code leaders includes a transmission unit which transmits the code as read to said host computer through the communication terminal corresponding thereto and the Internet, wherein said host computer includes a processing unit which performs a predetermined process by the use of the code as transmitted from said local code leader, wherein the transmission unit outputs the code, address information (for example, URL) of said host computer and a command to said communication terminal, and wherein the code is transmitted to said host computer indicated by the address information by the communication terminal through the Internet in response to the command

In accordance with this structure, the local code reader outputs the address information of the host computer and the command to the communication terminal together with the code. In response to this, the communication terminal transmits the code to the host computer. Namely, the transmission of the code can be triggered by scanning the code. Because of this, the user of the local code reader can transmit the code to the host computer only by reading the code through the local code reader without need for any particular operation of the communication terminal. In addition, the user need neither install software in the communication terminal nor input the address information of the host computer for transmitting the code to the host computer. As a result, it is possible to improve the convenience of the user.

In the case of the remote code leader system according to the fourth aspect as described above, the transmission unit outputs the code, the address information and the command to said communication terminal as keyboard data. Also, the command is a command for instructing an operating system which is installed in said communication terminal. For example, while the operating system is Windows (registered trademark), and the command is a command for instructing said communication terminal to launch a browser and output as the keyboard data corresponding to a GUI (Graphical User Interface) key +“R” key of a keyboard.

Since the command for an OS such as Windows which is taking a significant market share is output by the local code reader, it is possible to make use of most terminals as the communication terminal (for example, a personal computer) by an easy procedure, i.e., only by connecting the local code reader to the communication terminal.

In accordance with a fifth aspect of the present invention, a remote code leader system comprises: a plurality of local code leaders (for example, local barcode reader) each of which is capable of reading a code (for example, barcode) and connected with a communication terminal which is provided corresponding to the each local code leader and connectable with the Internet; and a host computer operable to receive a plurality of the codes transmitted from the plurality of said local code leaders respectively, wherein each of said local code leaders includes a transmission unit which transmits the code as read to said host computer through the communication terminal corresponding thereto and the Internet, wherein said host computer includes a processing unit which performs a process by the use of the code as transmitted from said local code leader, and wherein the processing unit performs a different process corresponding to the same code in accordance with the location where said communication terminal is installed (in other words, the location from which the code is transmitted).

In accordance with this structure, the host computer can perform processing by taking into consideration the mental state of the user and the step (for example, the step after or before purchasing, away from home or at home) in which the user is when purchasing the commodity (to which a code is attached), it is possible to effectively provide services and content by taking into consideration the mental state of the user and in which step the user is when purchasing the commodity. This is because differences in the installation locations of the communication terminals (in other words, the locations from which the codes are transmitted), i.e., the locations the users stay, may result in differences in regard to the mental state of the user and in accordance with in which step the user is when purchasing the commodity.

For example, the installation location of said communication terminal (in other words, the location from which the code is transmitted) can at least be either a personal residence or a store, wherein the processing unit receives, from said communication terminal installed in the personal residence, the information for determining that said communication terminal is installed in the personal residence (in other words, the code is transmitted from the personal residence), and receives, from said communication terminal installed in the store, the information for determining that said communication terminal is installed in the store (in other words, the code is transmitted from the store).

In accordance with a sixth aspect of the present invention, a remote code leader system comprises: a plurality of local code leaders (for example, local barcode reader) each of which is capable of reading a code (for example, barcode) and connected with a communication terminal which is provided corresponding to the each local code leader and connectable with the Internet; and a host computer operable to receive a plurality of the codes transmitted from the plurality of said local code leaders respectively, wherein each of said local code leaders includes a transmission unit which transmits the code as read to said host computer through the communication terminal corresponding thereto and the Internet, and said host computer comprises: a receiver unit operable to receive the codes which are transmitted from said local code leaders; a classification unit operable to classify each of the received codes into one of a plurality of groups; and a processing unit operable to perform, by the use of each of the received codes, a process corresponding to the group to which the each of the received codes belongs, wherein at least one of the groups is a group consisting of common product codes.

In accordance with this structure, the host computer classifies a code as received into either the group consisting of common product codes or another group, and processing is performed in accordance with the result of classification. The common product codes are originally designed for use in the POS system rather than for use in the present system. In other words, the common product codes are provided independently of the present system, and widely distributed in the world for the aforementioned purpose. Accordingly, the present system can provide services by the use of the common product codes which have been widely distributed in the world. On the other hand, the codes other than the common product codes are designed for the purpose of providing a particular service by the use of the present system, but not designed for use in the POS system. Namely, the codes other than the common product codes are provided for use in the present system. Accordingly, in correspondence with the codes other than the common product codes, a variety of services can be provided by the present system in accordance with the purposes of preparing these codes.

As discussed above, while the common product codes are different from the other codes in nature and feature, the user can scan these codes by the use of the same code reader without awareness of this fact, and receive the service provided in accordance with the group consisting of common product codes and a variety of services in accordance with the various codes belonging to the other group.

In addition, the user can easily obtain a good to which a common product code having been widely distributed is attached, and the present system can readily be available only with the code reader on the assumption that an appropriate network environment has been established. On the other hand, the user can receive a wide variety of different services by scanning the codes belonging to the group other than the common product code group.

Furthermore, on the system installation side, since the common product codes having been widely distributed can be used, it requires smaller labor as compared with the case where only the other codes are used.

In the case of the remote code leader system according to the sixth aspect as described above, the common product code is a code which is used in a POS (Point Of Sale) system. For example, the common product code is a code according to JAN (Japanese Article Number), EAN (European Article Number), or UPC (Universal Product Code).

In the case of the remote code leader system according to the sixth aspect as described above, when the code as received is an instore code, the processing unit returns a predetermined message.

In the case of the remote code leader system according to the sixth aspect as described above, when the code as received belongs to the group consisting of common product codes, the processing unit searches for information for generating a portal screen which is specific to a commodity corresponding to the code as received, and transmits the information for generating the portal screen as a search result to said communication terminal.

In the case of the remote code leader system according to the sixth aspect as described above, the codes belonging to another group than the group consisting of common product codes are assigned to articles as codes which are assigned for providing said communication terminal with content items corresponding to the codes respectively through said host computer, the common product code being excluded from the another group, wherein the articles include tangible entities inclusive of goods or estate, intangible entities inclusive of service or information, commodities, and living things inclusive of human being and animals, and wherein the information includes an image, a sound, a program or data.

In the case of the remote code leader systems according to the first through sixth aspects as described above, the codes are assigned to articles which include tangible entities inclusive of goods or estate, intangible entities inclusive of service or information, commodities, and living things inclusive of human being and animals, and wherein the information includes an image, a sound, a program or data.

In the case of the remote code leader systems according to the first through sixth aspects as described above, the one-dimensional codes are one-dimensional barcodes, the two-dimensional codes are QR codes, and the IC tags are RFID tags. For example, the one-dimensional codes are one-dimensional barcodes, the two-dimensional codes are QR codes, and the IC tags are RFID tags.

In accordance with a seventh aspect of the present invention, a computer-readable storage medium has stored thereon a program for performing the functionality of the host computer in accordance with any one of the first through sixth aspects. The computer-readable storage medium includes, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge.

In accordance with an eighth aspect of the present invention, a local code leader (for example, local barcode reader) is connected to a communication terminal which is connectable with the Internet, and connected to a host computer through the communication terminal and the Internet, and comprises: a reading unit operable to read a code (for example, barcode); a decoding unit operable to decode the code which is read by said reading unit, and acquire code information indicated by the code; and an output unit operable to output address information (for example, URL) of the host computer and the code information acquired by said decoding unit, to a communication terminal.

In accordance with this structure, the address of the host computer is output from the local code leader to the communication terminal together with the code information. Because of this, it is not required to input the address of the host computer, and thereby it is possible to improve the convenience of the user.

In the case of the local code leader according to the eighth aspect as described above, said output unit is further operable to output, to the communication terminal, a command for instructing the communication terminal to transmit the code information to the host computer.

In accordance with this configuration, the local code reader outputs the command to the communication terminal together with the code information and the address information of the host computer. Because of this, software need not be installed in the communication terminal for transmitting the code information to the host computer, and thereby it is possible to further improve the convenience of the user.

In the case of the local code leader according to the eighth aspect as described above, said output unit outputs the code information, the address information and the command as keyboard data to the communication. The command is a command for instructing an operating system which is installed in the communication terminal. For example, while the operating system is Windows (registered trademark), and the command is a command for instructing said communication terminal to launch a browser and output as the keyboard data corresponding to a GUI (Graphical User Interface) key +“R” key of a keyboard.

Since the command for an OS such as Windows which is taking a significant market share is output by the local code reader, it is possible to make use of most terminals as the communication terminal (for example, a personal computer) by an easy procedure, i.e., only by connecting the local code reader to the communication terminal.

In accordance with a ninth aspect of the present invention, a local code leader (for example, local barcode reader) is connected to a communication terminal which is connectable with the Internet, and connected to a host computer through the communication terminal and the Internet, the local code leader comprises: a reading unit operable to read a code (for example, barcode); a decoding unit operable to decode the code which is read by said reading unit, and acquire code information indicated by the code; and an output unit operable to output the code information acquired by said decoding unit to the host computer through the terminal communication and the Internet, wherein the code information is transmitted to the host computer by the communication terminal through the Internet in response to transmission of the code from said output unit.

In accordance with this structure, since the operation of scanning a code serves as a trigger, the user can transmit the code information to the host computer only by reading the code through a local code reader without need for any particular operation of the terminal. Namely, it is possible to improve the convenience of the user.

In the case of the local code leader according to the ninth aspect as described above, said output unit outputs, to the communication terminal, a command for instructing the communication terminal to transmit the code information to the host computer and the code information acquired by said decoding unit.

In accordance with this configuration, the local code reader outputs the command to the communication terminal together with the code information. Because of this, software need not be installed in the communication terminal for transmitting the code information to the host computer, and thereby it is possible to further improve the convenience of the user.

In the case of the local code leader according to the eighth and ninth aspects as described above, the codes are assigned to articles which include tangible entities inclusive of goods or estate, intangible entities inclusive of service or information, commodities, and living things inclusive of human being and animals, and wherein the information includes an image, a sound, a program or data.

In the case of the local code leader according to the eighth and ninth aspects as described above, the codes includes one-dimensional codes, two-dimensional codes, and/or codes which are stored in IC tags. For example, the one-dimensional codes are one-dimensional barcodes, the two-dimensional codes are QR codes, and the IC tags are RFID tags.

In accordance with a tenth aspect of the present invention, an advertisement support method is performed by making use of a terminal and a server which are connectable through a network, and the advertisement support method comprises: receiving code information given specific to each item of commodity from the terminal by the server; searching at the server for information necessary for generating a portal screen which is specific to each item of commodity in correspondence with the code information specific to the each item of commodity; and transmitting the information necessary for generating the portal screen by the server as a search result to said communication terminal.

In accordance with this structure, when the user who is interested in a commodity item or has purchased a commodity item transmits the code information given specific to the commodity item through the terminal installed in the store, the personal residence or the like, the terminal can receive information for generating the portal screen (hereinafter referred to as “individual portal screen”) of the commodity item from the server (hereinafter referred to as “advertisement support server”), and display this individual portal screen. Since this individual portal screen is a screen specific to the commodity indicated by the code information, it includes link information to the server of the manufacturer, vendor or the like (advertising client) distributing the information about the commodity, and so forth. Accordingly, the user of the terminal can easily access the server of the manufacturer, vendor or the like of the commodity through the individual portal screen, and can easily browse information about the desired commodity.

For the advertising client such as the manufacturer, vendor or the like, there is an advantage that the information about a commodity can be provided to the individual who is interested in the commodity or has purchased the commodity with pinpoint accuracy through the individual portal screen. In this regard, this system substantially differs from the conventional affiliate program.

On the other hand, for the user of the terminal, for example, when the user becomes interested in a commodity or wants to search some information about a purchased commodity, it is possible to display the individual portal screen which is specific to the commodity on the terminal only by transmitting the code information given specific to the commodity. The user can therefore easily access the target site through the individual portal screen. Because of this, it becomes much easier to acquire the information about the commodity as compared with the case where the information about the commodity is acquired by inputting terms, which seem to be related to the commodity, to a general purpose search engine, or by making use of a conventional portal site and searching for the information about the desired commodity among a number of commodities which are classified in a structured manner.

Also, when making use of a conventional technique such as a general purpose search engine or portal site service, such a situation may arise that the user cannot find which information is the information he wants from among a number of commodity sites having the equivalent or similar titles in the search results obtained by the conventional technique. However, such a situation can be avoided in accordance with the above system. Furthermore, in accordance with these conventional techniques, the search results often include misleading sites and informal sites, which become a hindrance when the advertising client wants website audience accessing the server thereof. However, such a situation can be avoided also in accordance with the above system.

As a consequence, it is possible to effectively support the terminal in accessing the server of the advertising client which distributes the information about a commodity.

Incidentally, the operating entity (hereinafter referred to as “advertisement support corporation”) running the advertisement support server which distributes the individual portal screen can make a profit from the advertising client when preparing the individual portal screen. For example, while charging no fee for the individual portal screen in which only the link information to the home page of the advertising client is displayed, a certain fee is charged to the advertising client who desires to display more link information items in the individual portal screen. The link information items increase in the individual portal screen in this manner.

If many link information items are displayed in the individual portal screen, the corresponding commodity can be advertised from a variety of angles, and thereby the users are more encouraged to buy the commodity than when a fewer link information items are displayed in the individual portal screen. In other words, when comparing similar commodities, the sales total of commodity products of the advertising client having the individual portal screen containing many link information items is expected to be larger than the sales total of commodity products of the advertising client having the individual portal screen containing a fewer link information items. Accordingly, the manufacturer, vendor or the like of the commodity is expected to desire to display extra link information items even if it requires paying a fee.

For the same reason, it is apparent that a difference occurs in sales between the store such as a retail store with the system installed on the basis of this advertisement support method, and another store without this system. Accordingly, most business entities operating stores are also expected to introduce the present system. In this case, the advertisement support corporation can make profits by charging the business entities operating the respective stores.

The code information given specific to each item of commodity as discussed herein includes the information which identifies the manufacturer or vendor of the commodity and the information which distinguishes the commodity.

This advertisement support method further comprises: detecting the code given specific to the each item of commodity by an input unit connected to the terminal; decoding the code as detected by the input unit to acquire the code information; and issuing a command, by the input unit, which instructs the terminal to launch a browser and to transmit the code information to the server.

By this configuration, the user of the terminal can transmit code information to the advertisement support server in response to the command issued from the input unit only by having the input unit detect the code which is attached and specific to the commodity, and thereby it is possible to display the individual portal screen without need for the user to strike a keyboard or click a mouse. A user-friendly system is therefore realized with which the individual portal screen can be displayed by a so-called zero-click operation. In addition to this, the terminal performs processing required for realizing the present system in response to the command issued from the input unit, and thereby it is possible to save the user the trouble of installing a new program in the terminal and so forth.

In the case of this advertisement support method, the code information is barcode information. By this configuration, it is possible to promote the use of the system for realizing this advertisement support method by making use of barcode information which is widely distributed for distinguishing each item of commodity and identifying the manufacturer.

In the case of this advertisement support method, the portal screen includes link information to a site provided for a commodity indicated by the code information. For example, the link information includes link information to a home page of an advertising client of the commodity indicated by the code information, link information to a site in which a commercial video of the commodity indicated by the code information is distributed, link information to a site in which the commodity indicated by the code information can be purchased, link information to a site in which the image of the commodity is displayed, link information to a site in which commodity description is given for the commodity indicated by the code information, link information to a site in which user registration can be done in relation to the commodity, link information to a site in which a questionnaire can be conducted in relation to the commodity indicated by the code information, link information to a site in which after-sales service is provided for the commodity indicated by the code information, or any arbitrary combination thereof. By this configuration, it is possible to provide the user the information about the commodity itself from a variety of angles.

Also, in the case of this advertisement support method, the portal screen includes link information to a site in which user registration can be done, link information to a site in which a questionnaire can be conducted, or any arbitrary combination thereof. By this configuration, it is possible to collect user information and perform the aggregation of questionnaire for market research or the like through the individual portal screen.

Furthermore, in the case of this advertisement support method, the portal screen includes link information to a site of a store or a retailer, which sells commodity products indicated by the code information.

In accordance with an eleventh aspect of the present invention, an advertisement support method is performed by making use of a terminal and a server which are connectable through a network, and the advertisement support method comprises: receiving a request for information, which is used to display a portal screen specific to a commodity, by the server from the terminal; and transmitting the information, which is used to display the portal screen, to the terminal by the server in response to the request, wherein the portal screen is provided individually for each item of commodity.

In accordance with a twelfth aspect of the present invention, a computer-readable storage medium has stored thereon a program for performing the advertisement support method in accordance with the tenth or eleventh aspect as described above. The definition of the storage medium is as described above.

In accordance with an thirteenth aspect of the present invention, an input device can be placed in an arbitrary location and used by connecting it to a computer connected with the Internet, and comprises: an imaging unit operable to take an image of a code attached to an article held by a user in his hand; a decoding unit operable to decode the image of the code as taken, and acquire code information indicated by the code; an output unit operable to output the code information to the computer; and a calculation unit operable to calculate the motion amount of an image of the article or code contained in the image taken by said imaging unit, wherein said output unit outputs the motion amount to the computer.

By this configuration, the input unit functions not only as a means for acquiring code information but also as a pointing device. Accordingly, after taking an image of the code attached to a good for the purpose of acquiring the code information by the input unit, the user can perform operation through the screen displayed on the computer only by moving the good which faces the input unit, and thereby the structure is very user-friendly. Also, since it is only required as input operation to image the cord, the manipulation is very simple.

The input device as described above further comprises a storing unit operable to store the address information (for example, URL) of a predetermined server and a predetermined command, wherein said output unit outputs the address information and the predetermined command to the computer together with the code information, and wherein the predetermined command is a command for instructing the computer to transmit the code information to the predetermined server.

By this configuration, the user can access the server only by having the input unit take an image of the code attached to a good such that the computer automatically transmits the code information to the server in response to the command issued from the input unit, without need for cumbersome operation performed by the user (the computer need not be manipulated).

In the case of the input device as described above, the code is a one-dimensional code and/or a two-dimensional code. For example, the one-dimensional code is a one-dimensional barcode, and the two-dimensional code is a QR code.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the overall configuration of a remote barcode reader system in accordance with an embodiment of the present invention.

FIG. 2(a) is a schematic diagram for showing the electric configuration of a local barcode reader 7 shown in FIG. 1. FIG. 2(b) is an explanatory schematic diagram for showing programs and data segments stored in a ROM 19 embedded in an MCU (Microcontroller Unit) 15 shown in FIG. 2(a).

FIG. 3 is a schematic diagram for showing one example of the communication procedure among the local barcode reader 7, a communication terminal 5 and a host computer 1 as illustrated in FIG. 1.

FIG. 4 is a schematic diagram for showing the overall configuration of an advertisement support system to which the remote barcode reader system shown in FIG. 1 is applied.

FIG. 5(a) is a schematic diagram for showing the general outline of the advertisement support system. FIG. 5(b) is a view for showing a first individual portal screen 100 which is a first example of the individual portal screen provided for a certain commodity.

FIG. 6(a) is a schematic diagram for showing the electric configuration of the advertisement support server 31 shown in FIG. 4. FIG. 6(b) is a schematic representation showing programs and data segments stored in the storage area 200 of the advertisement support server 31 shown in FIG. 6(a). FIG. 6(c) is a schematic diagram for showing the configuration of the first individual portal screen file 230 shown in FIG. 6(b).

FIG. 7 is a flow chart showing an example of the communication procedure in accordance with the advertisement support system shown in FIG. 4.

FIG. 8 is a schematic diagram for showing one example of the communication procedure between an e-commerce server and a PC 43 after it is determined in step S208 of FIG. 7 that this server is addressed by the URL.

FIG. 9 is a view for showing an example of the first individual portal screen 130 of an application example 1.

FIG. 10 is a view for showing an example of the individual portal screen table which is referred to when generating the first individual portal screen 130 shown in FIG. 9.

FIG. 11(a) is a view for showing an example of the second individual portal screen 101 of the application example 2. FIG. 11(b) is a schematic representation of a program storing section 199 of the application example 2. FIG. 11(c) is a schematic representation of the second individual portal screen file 222 of the application example 2. FIG. 11(d) is a schematic diagram for showing the configuration of the second individual portal screen file 222 of the application example 2.

FIG. 12 is a flow chart for showing the process of generating an individual portal screen of the application example 2.

FIG. 13 is a flow chart for showing an example of the communication procedure among the server 47 of the advertising client 45-M, the computer 37 of the store 35-K, and the advertisement support server 31 in the case of the application example 2.

FIG. 14 is a flow chart for showing an example of the communication procedure between the server 77 of a store central office 75-P and the computer 37 after it is determined in step S608 of FIG. 13 that the server 77 is addressed by the URL.

FIG. 15 is an explanatory view for showing the application example 3.

FIG. 16 is an explanatory view for showing a program storing section 172 of the application example 3.

FIG. 17 is a flow chart for showing the process of generating an individual portal screen in the case of the application example 3.

FIG. 18 is a perspective external view for showing a camera unit 180 of the application example 4.

FIG. 19 is a schematic diagram for showing the electric configuration of the camera unit 180 as shown in FIG. 18.

FIG. 20 is a flow chart for showing an example of the process of scanning a barcode by an MCU 192.

FIG. 21 is a flow chart for showing an example of processing mouse operation by the MCU 192.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated.

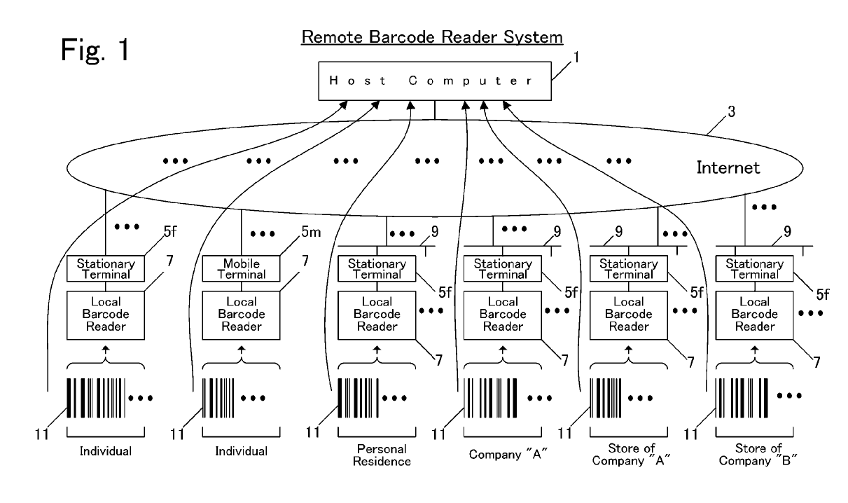

FIG. 1 is a view showing the overall configuration of a remote barcode reader system in accordance with the embodiment of the present invention. Referring to FIG. 1, the remote barcode reader system includes a host computer 1, and a plurality of arbitrary local barcode readers 7 capable of reading arbitrary barcodes 11. The local barcode reader 7 may be for example a pen scanner, a CCD touch scanner, a handheld laser scanner, a desktop laser scanner, a slot reader, or any other type of barcode reader.

In the context of this document, the term “barcode” is intended to generally represent the information contained in a barcode or the pattern of a barcode, so that when there is no need to distinguish the barcode information and the barcode pattern, the term “barcode” is simply used. From a different view point, the barcode is a code which is assigned to an article (tangible entity such as goods or estate, intangible entity such as service or information (image, sound, program, data or the like), commodity, or, human being, animal or another living being), or any other thing which can be identified by some means.

The barcode information represents a string of characters such as numerals, letters, symbols and the like. The barcode pattern is a pattern of black bars and white spacings which are combined in order to encode the barcode information. Incidentally, the barcode and the barcode pattern are given the same reference numeral “11”.

The host computer 1 and each of the local barcode readers 7 are connected with each other through the Internet 3, and a stationary terminal 5f or a mobile terminal 5m. The stationary terminal 5f may be any type of fixed line terminal such as a desktop computer provided with communication functionality. The mobile terminal 5m may be any type of wireless communication terminal such as a notebook computer or any type of portable computer, which is provided with communication functionality, a cellular phone, or a PDA (Personal Digital Assistant). Incidentally, when there is no need to distinguish the stationary terminal 5f and the mobile terminal 5m, the term “terminal 5” is simply used.

The illustrated example will be explained. The local barcode reader 7 used by a certain individual is connected to the Internet 3 through the stationary terminal 5f and an access network which is not shown in the figure, and connected to the host computer 1 through an access network which is not shown in the figure. The local barcode reader 7 used by another individual is connected to the Internet 3 through the mobile terminal 5m and an access network which is not shown in the figure, and connected to the host computer 1 through the access network. The local barcode reader 7 used in the house of an individual is connected to the Internet 3 through the stationary terminal 5f, a user network 9 such as a LAN and an access network which is not shown in the figure, and connected to the host computer 1 through the access network.

The local barcode reader 7 used in a company “A” (company having a chain of convenience stores) is connected to the Internet 3 through the stationary terminal 5f, a user network 9 such as a LAN and an access network which is not shown in the figure, and connected to the host computer 1 through the access network. The local barcode reader 7 used in a store (for example, a convenience store) operated by the company “A” is connected to the Internet 3 through the stationary terminal 5f, a user network 9 such as a LAN and an access network which is not shown in the figure, and connected to the host computer 1 through the access network.

The local barcode reader 7 used in a store operated by a company “B” which is a different company than the company “A”, for example, a rival company is connected to the Internet 3 through the stationary terminal 5f, a user network 9 such as a LAN and an access network which is not shown in the figure, and connected to the host computer 1 through the access network.

In this case, the local barcode readers 7 and the stationary terminals 5f used in the stores of the companies “A” and “B” are not POS terminals. However, they can be POS terminals.

While the example shown in the figure is illustrative only, a number of various and arbitrary local barcode readers 7 are connected with the host computer 1 through various networks inclusive of the Internet 3, regardless of the individuals and enterprises. Accordingly, the host computer 1 can globally collect a number of various and arbitrary barcodes. The barcodes 11 are classified into a plurality of groups. The host computer 1 performs a process in accordance with the group to which the barcode 11 belongs, and provides a service to the user by performing this process. In this case, the host computer 1 can provide a service (including content) through the terminal 5 and the Internet 3. However, in response to the processing result of the host computer 1, it is possible to provide a service through not only the Internet 3 but also WAN (Wide Area Network), LAN (Local Area Network) or any other network, or a combination thereof. The barcodes 11 can be collected in the same manner. Incidentally, WAN includes a public switched telephone network, an exclusive line network, a power line communication network, a CATV network and so forth. Alternatively, in response to the processing result of the host computer 1, it is also possible to provide a service through another route (broadcast, postal mail, another communication tool, door-to-door parcel delivery service, and so forth) without using a network. In other words, while the network has to be used for collecting the barcodes 11, any other appropriate means can be used for providing a service to the user.

Next, the above groups into which the barcodes 11 are classified will be described by way of example. The first example is a group of barcodes which are printed on paper mediums such as magazines. The host computer 1 receives a barcode belonging to this group, gives the terminal 5 the URL of a website in which is placed the information about the paper medium printed with the barcode, or content described in the paper medium (for example, advertisement). The information is then displayed on the terminal 5. The second example is a group of barcodes which are assigned to companies respectively in a printed material such as Kaisha Shikiho describing stock price information. The host computer 1 receives a barcode belonging to this group, gives the terminal 5 the URL of a website in which is placed the stock price information about the company corresponding to this barcode. The information is then displayed on the terminal 5.

The third example is a group of barcodes which are assigned to companies respectively in a printed material describing job information. The host computer 1 receives a barcode belonging to this group, gives the terminal 5 the URL of a website in which is placed the job information about the company corresponding to this barcode. The information is then displayed on the terminal 5. The fourth example is a group of barcodes which are assigned to landscapes respectively in a printed material showing landscape photographs. The host computer 1 receives a barcode belonging to this group, gives the terminal 5 the URL of a website in which is placed the detailed information about the landscape corresponding to this barcode. The information is then displayed on the terminal 5.

The fifth example is a group of barcodes which are assigned to articles respectively in a newspaper. The host computer 1 receives a barcode belonging to this group, gives the terminal 5 the URL of a website in which is placed the detailed information about the article corresponding to this barcode. The information is then displayed on the terminal 5. The sixth example is a group of barcodes which are assigned to name cards respectively. The host computer 1 receives a barcode belonging to this group, gives the terminal 5 the URL of a website in which is placed the detailed information about the holder of the name card corresponding to this barcode. The information is then displayed on the terminal 5.

The seventh example is a group of barcodes which are assigned to chapters of a book respectively. The host computer 1 receives a barcode belonging to this group, gives the terminal 5 the URL of a website in which is placed the detailed information about the chapter corresponding to this barcode. The information is then displayed on the terminal 5. The eighth example is a group of barcodes which are assigned to the titles of music CDs or cinema DVDs respectively. The host computer 1 receives a barcode belonging to this group, gives the terminal 5 the URL of a website which enables listening/watching the music or movie corresponding to this barcode. The title is played on the terminal 5.

The ninth example is a group of barcodes which are assigned to pictures of trading cards respectively. The host computer 1 receives a barcode belonging to this group, gives the terminal 5 the URL of a website in which is placed the information about the picture corresponding to this barcode. The information is then displayed on the terminal 5. The tenth example is a group of barcodes which are printed on purchase receipts issued after shopping respectively. The host computer 1 receives a barcode belonging to this group, gives the terminal 5 the URL of a website in which is placed the information about the store having issued the purchase receipt corresponding to this barcode (for example, information for sale). The information is then displayed on the terminal 5.

The eleventh example is a group of barcodes corresponding to standard commodity codes. The host computer 1 receives a barcode belonging to this group, gives the terminal 5 the URL of a website in which is placed the information about the good corresponding to this barcode. The information is then displayed on the terminal 5. The standard commodity codes are codes used by a POS (Point Of Sale) system, and include codes according to JAN (Japanese Article Number), EAN (European Article Number), and UPC (Universal Product Code) and so forth.

As has been discussed above, in accordance with the present system, while the barcode 11 is classified into one of the plurality of groups, the host computer 1 performs the process corresponding to the group to which the received barcode 11 belongs, and provides the terminal 5 with the content which is given according to this group and corresponding to the received barcode 11. Incidentally, the aforementioned groups are illustrative only, but needless to say the present invention is not limited thereto.

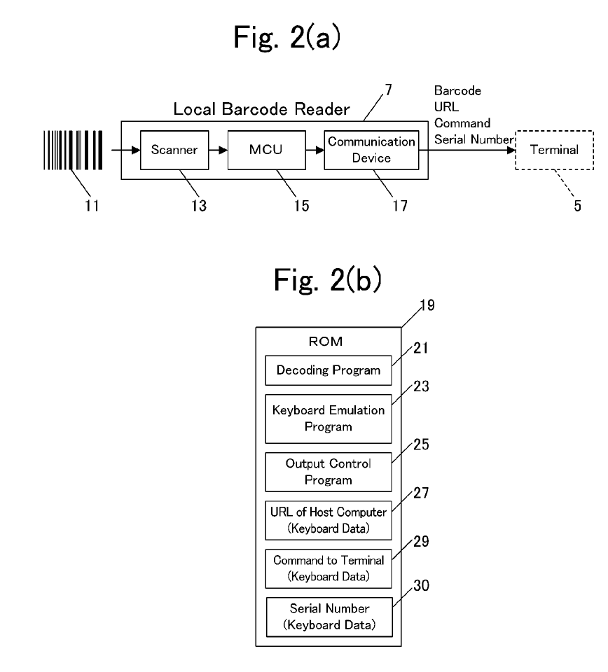

FIG. 2(a) is a schematic diagram for showing the electric configuration of the local barcode reader 7 shown in FIG. 1. FIG. 2(b) is an explanatory schematic diagram for showing programs and data segments stored in a ROM 19 embedded in an MCU (Microcontroller Unit) shown in FIG. 2(a). Referring to FIG. 2(a), the local barcode reader 7 includes a scanner 13, the MCU 15 and a communication device 17. The scanner 13 optically reads a barcode pattern 11, and converts (scans) bars and spacings into an electrical signal. In this case, the scanning process can be arbitrarily performed as described above. The electrical signal corresponding to the barcode pattern 11 is given to the MCU 15 from the scanner 13.

The MCU 15 includes, as built-in elements, a CPU (not shown in the figure), a RAM (not shown in the figure), an A/D converter, the ROM 19 shown in FIG. 2(b) and so forth. The ROM 19 is used to store a decoding program 21, a keyboard emulation program 23, an output control program 25, a URL (Uniform Resource Locator) 27 of the host computer 1 provided in terms of keyboard data, a command 29 provided in terms of keyboard data to be issued to the terminal 5, a serial number 30 provided in terms of keyboard data, and any other necessary programs and data.

The command 29 is a command which is used to instruct the terminal 5 to run a browser and access the host computer 1 by the use of the URL 27. For example, in the case where the OS (Operating System) is Windows (registered trademark), the command is provided as the keyboard data corresponding to a GUI (Graphical User Interface) key +“R” key of a keyboard if the OS is Windows 98 or latter version. Windows launches a browser (Internet Explorer (registered trademark)) in response to this command. In other words, this command is included as a default command of Windows which is an OS. Meanwhile, the GUI key of Windows is generally referred to as Windows key. Since the local barcode reader 7 stores and outputs the command of an OS such as Windows which is taking a significant market share, it is possible to make use of most terminals as the terminal 5 by an easy procedure, i.e., only by connecting the local barcode reader 7 to the terminal 5. Because of this, the local barcode reader 7 need not store a plurality of commands in advance, and recognize the OS used by each terminal 5, select and use one of the commands, and so forth.

The serial number 30 is a unique number that is assigned to identify the local barcode reader 7.

The MCU 15 runs the decoding program 21, decodes the electrical signal corresponding to the barcode pattern 11 which is input, and acquires the barcode information. Then, the MCU 15 runs the keyboard emulation program 23, converts the barcode information into keyboard data, and stores the keyboard data in the RAM. The MCU 15 runs the output control program 25, acquires the command 29, the URL 27 and the serial number 30 from the ROM 19, acquires the barcode information from the RAM, and transfers the keyboard data thereof to the communication device 17.

The communication device 17 is, for example, a USB controller or the like, and transmits the keyboard data (the command 29, the URL 27, the barcode information and the serial number 30) which is received from the MCU 15, to the terminal 5. Then, in response to the received command 29, the terminal 5 transmits the barcode information and the serial number 30 to the host computer 1 with reference to the received URL 27 through the Internet 3. Incidentally, while the personal information of the user can optionally be registered from the terminal 5, it requires careful handling. In connection with the serial number 30 which is acquired by the host computer 1, the personal information has to be handled particularly in a careful way.

Meanwhile, it is possible to make changeable the URL and the programs by the use of an EEPROM, a flash memory or the like, provided outside the MCU 15. In addition, while the MCU 15 and the communication device 17 are illustrated as separate units in the figure, they can be incorporated in a single unit.

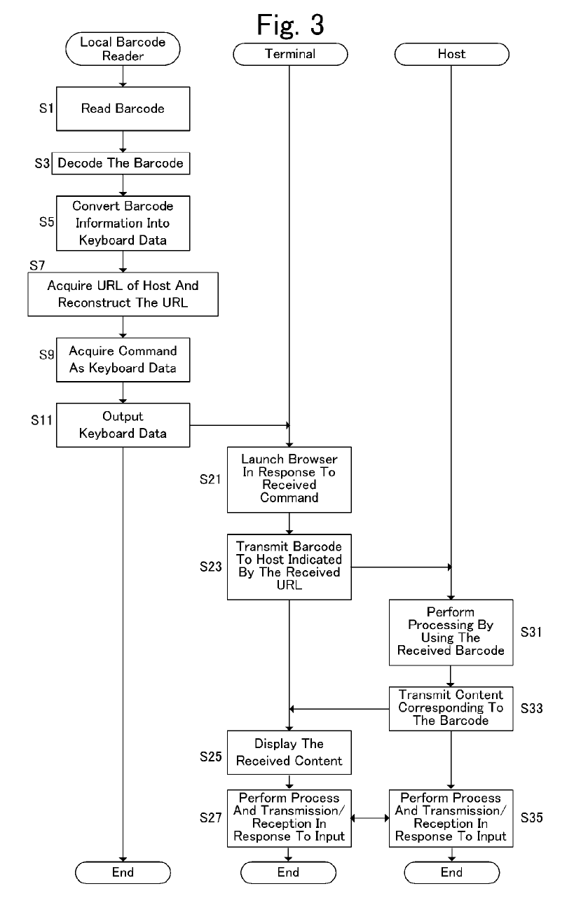

Referring to FIG. 3, in step S1, the local barcode reader 7 reads the barcode pattern 11 in response to the operation of the user. In step S3, the local barcode reader 7 decodes the barcode pattern 11 on the basis of a known barcode decoding technique.

In step S5, the local barcode reader 7 converts the barcode information which is the result of decoding into keyboard data, and stores the keyboard data in the RAM. Then, in step S7, the local barcode reader 7 acquires the URL 27 of the host computer 1 (for example, “http://www.ssd.co.jp”) from the ROM 19 as keyboard data, appends the barcode information (for example, “4560256580016”) and the serial number 30 (for example, “13222159”) as keyboard data to the end of the URL 27, and stores it in the RAM as a new URL (for example, “http://www.ssd.co.jp/?bc=4560256580016&sn=13222159”).

In step S9, the local barcode reader 7 acquires the command 29 from the ROM 19 in the form of keyboard data which instructs the terminal 5 to launch the browser and access the host computer 1, and stores the command 29 in the RAM. In step S11, the local barcode reader 7 outputs the keyboard data (the command 29 and URL (URL 27+barcode information+serial number 30) to the terminal 5.

The terminal 5 receives the keyboard data which is output from the local barcode reader 7. Then, the terminal 5 launches the browser in response to the command 29 received from the local barcode reader 7 in step S21, and accesses the host computer 1 with reference to the URL received from the local barcode reader 7 in step S23. At this time, the URL is transmitted to the host computer 1.

The host computer 1 then receives the URL (including the barcode information and the serial number 30). And, in step S31, the host computer 1 performs the process corresponding to the group to which the received barcode 11 belongs, and generates the content which is provided corresponding to this group and corresponding to the barcode information. In step S33, the host computer 1 transmits the content corresponding to the barcode information (for example, which is described in HTML) as a result of the process in step S31, to the terminal 5.

In step S25, the terminal 5 displays the content, which is transmitted from the host computer 1, in a display (for example, by parsing the HTML information and displaying a web page). In step S27, the terminal 5 performs processing and communication with the host computer 1 in response to the input operation by the user. Likewise, in step S35, the host computer 1 performs processing and communication with the terminal 5 in response to the access from the terminal 5. Meanwhile, the content transmitted from the host computer 1 to the terminal 5, i.e., the content which is provided for the user is an example of a service which is provided for the user. An example of a service which is provided for the user will be explained below as an application example of the present system.

Next is a supplementary explanation of step S23. More specifically, in step S23, the terminal 5 accesses a DNS (Domain Name

System) server, acquires an IP address corresponding to a domain name (“www.ssd.co.jp” in the aforementioned example), transmits the aforementioned URL including the barcode information and the serial number 30 to the network including the Internet 3 together with the IP address, and transmits the barcode information and the serial number 30 to the host computer 1 by accessing the host computer 1. However, detailed description of the above processing is dispensed with because these steps are performed by well-known protocols.

As has been discussed above, in the case of the present embodiment, a number of various and arbitrary local barcode readers 7 are connected with the host computer 1 through various networks inclusive of the Internet 3 and a number of arbitrary terminals 5 which are connected to these networks. In other words, a number of various and arbitrary local barcode readers 7 are connected with the host computer 1, regardless of the individuals and enterprises. Accordingly, the host computer 1 can globally collect a number of various and arbitrary barcodes 11. The host computer 1 performs a process in accordance with the group belonging to the barcode 11, and transmits to the terminal 5 the content which is provided corresponding to this group and corresponding to the barcode 11. Thereby, the terminal 5 can display a variety items of content in accordance with the barcodes 11. In other words, in response to the barcode 11 transmitted to the host computer 1, the user of the local barcode reader 7 can receive a variety of services which are provided by the host computer 1 in correspondence with the barcode 11. In this case, as long as the user possesses at least one local barcode reader 7, he can receive a variety of different services. For example, the user can receive any service of the first to eleventh examples as described above only by the use of a single local barcode reader 7. In addition to this, only by scanning a barcode 11, the user of the local barcode reader 7 can readily receive the service and content provided corresponding to this barcode 11 with no need to search websites for receiving the desired service and content.

Furthermore, in the case of the present embodiment, the local barcode reader 7 outputs the URL 27 of the host computer 1 and the command 29 to the terminal 5 together with the barcode 11. In response to this, the terminal 5 transmits the barcode 11 to the host computer 1. Namely, the transmission of the barcode 11 can be triggered by scanning the barcode 11. Because of this, the user of the local barcode reader 7 can transmit the barcode 11 to the host computer 1 only by reading the barcode 11 through the local barcode reader 7 without need for any particular operation of the terminal 5. In addition, the user need neither install software in the terminal 5 nor input the URL 27 of the host computer 1 for transmitting the barcode 11 to the host computer 1. As a result, it is possible to improve the convenience of the user.

Furthermore, since the serial number 30 of the local barcode reader 7 is transmitted to the host computer 1, the user can receive content provided for him irrespective of the terminal 5 to which his own local barcode reader 7 is connected. In other words, as long as the user uses his own local barcode reader 7, the user can receive content provided for him through the arbitrary terminal 5. Needless to say, in this case, the host computer 1 performs a process associated with the serial number 30 of the local barcode reader 7, and transmits content corresponding to the serial number 30, to the terminal 5. Meanwhile, the transmission of the serial number 30 from the local barcode reader 7 or the terminal 5 is optionally performed, but can be dispensed with.

Incidentally, while the host computer 1 serves as a Web server in the above example, the present invention is not limited thereto. However, of course, the present invention can also be applied in a different way in which the protocol supported by the host computer 1 serving as another type of server is used with a different URL. The host computer 1 may further be provided with a plurality types of server functions.

Next, several practical applications of the remote barcode reader system shown in FIG. 1 will be explained.

### APPLICATION EXAMPLE 1

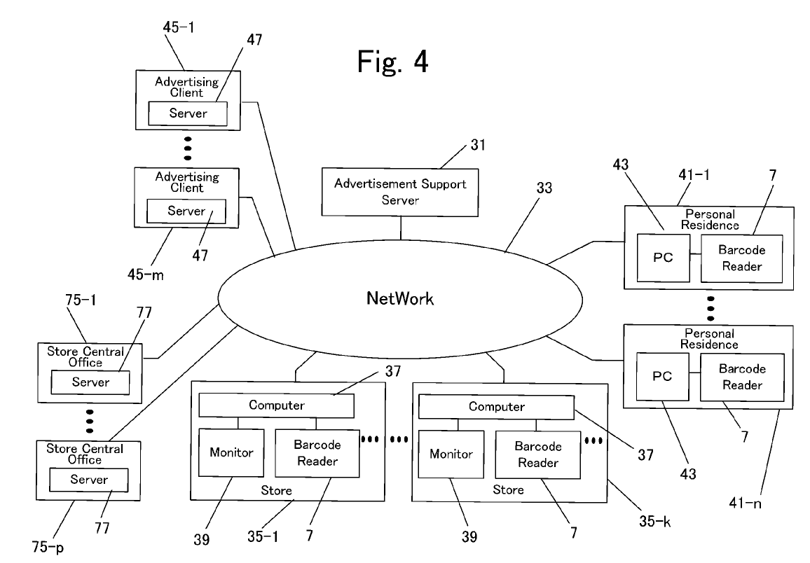

FIG. 4 is a schematic diagram for showing the overall configuration of an advertisement support system to which the remote barcode reader system shown in FIG. 1 is applied. Referring to FIG. 4, this advertisement support system includes an advertisement support server 31 which is connected to a network 33. The network 33 includes various networks such as the Internet, LAN (Local Area Network) and so forth.

Each of personal residences 41-1 to 41-n (“n” is one or a lager integer) is provided with a personal computer (hereinafter referred to as “PC”) 43 to which is connected a barcode reader 7 for reading the barcode attached to a commodity product. Also, the PC 43 is connected to the network 33.

Each of stores 35-1 to 35-k (“k” is one or a lager integer) is provided with a computer 37 to which are connected a monitor 39 and a barcode reader 7 for reading the barcode attached to a commodity product. Particularly, a plurality of sets of these peripherals are provided in each of the stores 35-1 to 35-k which are connected to the network 33 through the computers 37 thereof respectively.

Each of store central offices 75-1 to 75-p (“p” is one or a lager integer) is provided with a server 77 and connected the network 33.

Each of advertising clients 45-1 to 45-m (“m” is one or a lager integer) of the various commodities is provided with a server 47 and connected the network 33.

In this case, the personal residences 41-1 to 41-n are collectively referred to as the “personal residence 41-N”, the stores 35-1 to 35-k are collectively referred to as the “store 35-K”, the advertising clients 45-1 to 45-m are collectively referred to as the “advertising clients 45-M”, and the store central offices 75-1 to 75-p are collectively referred to as “the store central office 75-P”.

Known types of various servers can be used to provide the advertisement support server 31, the server 47 of the advertising client 45-M, and the server 77 of the store central office 75-P. However, these servers are implemented by Web servers as examples in the case of the present embodiment. Also, the advertising client 45-M is a business entity which is generally located in the upstream side of the commodity product flow, such as a manufacturer of commodity, a vendor of commodity products or the like. The store central office 75-P is a business entity which is generally located in the downstream side of the commodity product flow, such as a retailer or the like. The store 35-K is a store which is under the control of the store central office 75-P. The personal residence 41-N is the house of an end user.

In this example, the advertisement support server 31 corresponds to the host computer 1 shown in FIG. 1. The PC 43, the computer 37 and the monitor 39 correspond to the stationary terminals 5f shown in FIG. 1 respectively. The barcode reader 7 corresponds to the local barcode reader 7 shown in FIG. 1.

Next, the general outline of the advertisement support system shown in FIG. 4 will be explained. In this case, the communication among the advertisement support server 31, the personal residence 41-N and the advertising client 45-M will be explained as an example.

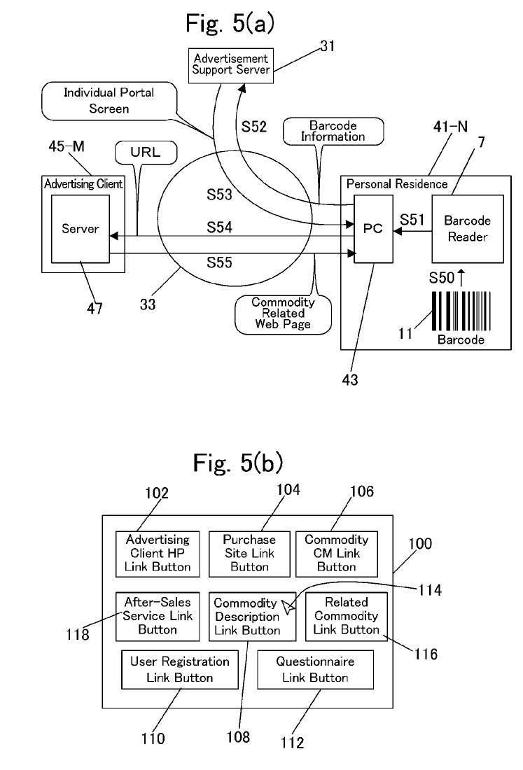

FIG. 5(a) is a schematic diagram for showing the general outline of the advertisement support system. Referring to FIG. 5(a), in step S50, the barcode reader 7 scans and decodes a barcode pattern 11 in response to user's operation, and acquires barcode information contained in the barcode pattern 11.

The PC 43 receives the barcode information which is output from the barcode reader 7 in step S51, and transmits the barcode information to the advertisement support server 31 through the network 33 in step S52. In step S53, the advertisement support server 31 transmits, to the PC 43 through the network 33, the information which can be used to display an individual portal screen provided in correspondence with the barcode information as received from the PC 43. The PC 43 then displays the individual portal screen on the basis of the information as received.

The individual portal (entrance) screen is a screen which is provided individually for each item of commodity for displaying link information related to the each commodity. In other words, the individual portal screens are provided in a one-to-one correspondence with the individual commodity items. FIG. 5(b) is a view for showing a first individual portal screen 100 which is a first example of the individual portal screen provided for a certain commodity. Referring to FIG. 5(b), the first individual portal screen 100 includes a link button 102 for opening the home page (HP) of the advertising client 45-M of the commodity indicated by barcode information, a link button 104 for opening a website in which the commodity indicated by the barcode information can be purchased, a link button 106 for opening a website in which a commercial message (CM) of the commodity indicated by the barcode information is distributed, the link button 118 for opening a website in which after-sales service is provided for the commodity indicated by the barcode information, a link button 108 for opening a website in which commodity description is given for the commodity indicated by the barcode information, a link button 116 for opening a website in which related commodities of the commodity indicated by the barcode information are described, a link button 110 for opening a website in which user registration can be done, and a link button 112 for opening a website in which a questionnaire can be conducted.

Also, a cursor 114 is displayed in the first individual portal screen 100. Meanwhile, in this example, the related commodities indicated by the link button 116 are commodities provided by the advertising client 45-M of the commodity indicated by the barcode information. Also, it is assumed that the link button 110 serves as a link to the site in which user registration can be made in the present system. Alternatively, the link button 110 may be a link to the site in which user registration can be made for the commodity indicated by the barcode information, or may be a link to the site in which user registration can be made for both the commodity and the present system. Furthermore, the link button 112 may be a link to the site in which a questionnaire can be conducted for the commodity indicated by the barcode information, may be a link to the site in which a questionnaire can be conducted for another purpose, or may be a link for both these purposes.

However, as a default process (for which the advertising client 45-M is not charged), only the link button 102 for opening the home page of the advertising client 45-M, the link button 110 for opening the website in which user registration can be made in the present system, and a link button 112 for opening the website in which the questionnaire can be conducted, are displayed. The other link buttons 104, 106, 108, 116 and 118 are displayed as options only after the advertising client 45-M becomes a member of the advertisement support system of the business entity (advertisement support corporation) running the advertisement support server 31. However, in the case where the link button 104 does not provide a link to the shopping website of the advertising client 45-M, but provides a link to the shopping website of another commodity retailer, the link button 104 is displayed as a default button. This is because, in this case, the advertisement support corporation can make profits by affiliate advertising.

The system of charging the members can be implemented as a fixed charge system such as the system of charging an annual fee for membership, a pay-per-click system for charging a fee in accordance with the number of times of clicking (pressing) the link buttons displayed in the first individual portal screen 100, a fee-for-result system for charging a fee in accordance with the result (purchase of a commodity and so forth) or any combination thereof.

When the user of the PC 43 presses either one of the link buttons 102, 104, 106, 108, 116 and 118, in step S54 of FIG. 5(a), the PC 43 accesses the server 47 of the advertising client 45-M through the network 33 on the basis of the URL corresponding to the link button which is pressed. The server 47 then transmits information for displaying the web page corresponding to the link button which is pressed, to the PC 43 through the network 33 in step S55. In response to this, the PC 43 displays the web page.

Returning to FIG. 4, the computer 37 and the monitor 39 of the store 35-K correspond to the PC 43 of the personal residence 41-N, and the barcode reader 7 of the store 35-K corresponds to the barcode reader 7 of the personal residence 41-N. Accordingly, the communication among the advertisement support server 31, the store 35-K and the advertising client 45-M is performed in the same manner as the communication among the advertisement support server 31, the personal residence 41-N and the advertising client 45-M as illustrated in FIG. 5(a), and therefore no redundant description is repeated.

Also, the content items of the individual portal screen displayed on the monitor 39 of the store 35-K are similar to the content items of the first individual portal screen 100 displayed on the PC 43 of the personal residence 41-N as shown in FIG. 5(b), and therefore no redundant description is repeated. However, in this case, it is also possible to display in the individual portal screen a link button specific to the store 35-K, for example, providing a link to a website describing information for sales, special services and the like information of the store 35-K.

When the advertisement support system is introduced to the store 35-K, it is preferred for the business entity operating the advertisement support server 31 to have the owner of the store 35-K be a member and to charge a predetermined fee such as an annual fee (in a fixed charge system). Also, in connection with the link button specific to the store 35-K, a pay-per-click system or a fee-for-result system may be employed as in the case of the advertising client 45-M.

Next, the advertisement support server 31 will be explained in detail.

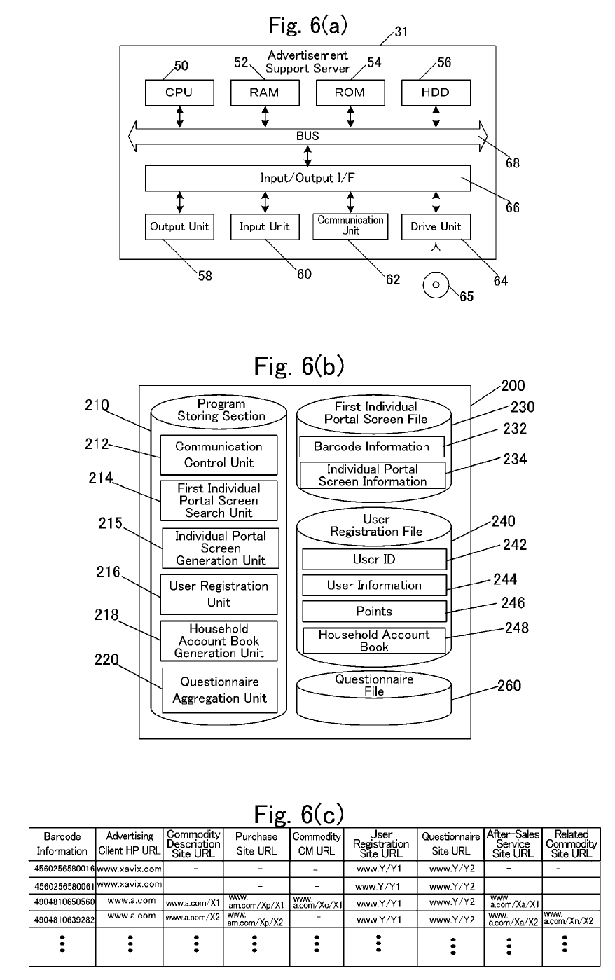

FIG. 6(a) is a schematic diagram for showing the electric configuration of the advertisement support server 31 shown in FIG. 4. Referring to FIG. 6(a), the advertisement support server 31 includes a CPU (Central Processing Unit) 50, a RAM (Random Access Memory) 52, a ROM (Read Only Memory) 54, a HDD (Hard Disk Drive) 56, an input/output interface (input/output I/F) 66, an output unit 58, an input unit 60, a communication unit 62, a drive 64 and a bus 68.

The CPU 50 is connected to the RAM 52, the ROM 54, the HDD 56, and the input/output I/F 66 through the bus 68. The input/output I/F 66 is connected to the output unit 58 such as an LCD display, the input unit 60 such as a mouse or a keyboard, the communication unit 62 such as a LAN card or a USB controller serving to make a connection with the network 33, and the drive 64 for driving a removable recording medium 65 such as CD-ROM, DVD -ROM, respectively.

Incidentally, the hardware configurations of the PC 43, the computer 37, the server 47 and the server 77 are similar to the hardware configuration of the advertisement support server 31, and therefore no redundant description is repeated. Also, the hardware configurations of the host computer 1 and the stationary terminal 5f shown in FIG. 1 are similar to the hardware configuration of the advertisement support server 31. Furthermore, the hardware configuration of the mobile terminal 5m shown in FIG. 1 is well known in the art.

FIG. 6(b) is a schematic representation showing the configuration of the storage area 200 of the advertisement support server 31. As shown in FIG. 6(b), the storage area 200 of the HDD 56 and the ROM 54 of the advertisement support server 31 includes a program storing section 210, a first individual portal screen file 230, a user registration file 240, and a questionnaire file 260.

The first individual portal screen file 230 is provided to form a database for storing barcode information 232 provided individually for each of commodities, and individual portal screen information 234 corresponding to each item of commodity indicated by the barcode information 232 in association with each other.

FIG. 6(c) is a schematic diagram for showing the configuration of the first individual portal screen file 230. Referring to FIG. 6(c), the first individual portal screen file 230 is a file in which, for each commodity, the barcode information 232 is associated with the individual portal screen information 234. The individual portal screen information 234 contains the URL of the home page of the advertising client corresponding to the link button 102 of FIG. 5(b), the URL of the commodity description site corresponding to the link button 108, the URL of the commodity purchase site corresponding to the link button 104, the URL of the commercial message site corresponding to the link button 106, the URL of the user registration site corresponding to the link button 110, the URL of the questionnaire site corresponding to the link button 112, the URL of the related commodity site corresponding to the link button 116, and the URL of the after-sales service site corresponding to the link button 118. Incidentally, the protocol indication (“http://”) is omitted in FIG. 6(c).

Returning to FIG. 6(b), the user registration file 240 is provided to form a database for storing user identification information (ID) 242, user information 244 which is registered through the first individual portal screen 100 (the link button 110) displayed on the PC 43 of the personal residence 41-N or the monitor 39 of the store 35-K, point information 246, and household account book information 248 in association with each other. The user information contains various information items including a name, a gender, an age, a birth date, a residence, a telephone number, an email address, a profession and other information relating to each user. The point information 246 indicates points to be added under predetermined conditions when the link button of the first individual portal screen 100 is pressed. A specific benefit is given to the user when the points have amounted to a predetermined number. The household account book information 248 is a file for storing a daily record of household expenses of the user. The user can access the household account book information 248 through the PC 43 or the computer 37 by inputting a user ID and a password.

The questionnaire file 260 is provided to form a database for storing the results of questionnaire collected through the first individual portal screen 100 (the link button 112) which is displayed the PC 43 of the personal residence 41-N or the monitor 39 of the store 35-K.

The program storing section 210 includes a communication control unit 212, a first individual portal screen search unit 214, an individual portal screen generation unit 215, a user registration unit 216, a household account book generation unit 218, and a questionnaire aggregation unit 220. These function units are implemented as programs of computer software, or subroutines of a program installed in the ROM and/or the HDD 56. These programs are stored in the removable recording medium 65, and installed in the advertisement support server 31 therefrom. Also, these function units will be explained by the use of the following flow chart.

Next, the communication procedure among the server 47 of the advertising client 45-M, the PC 43 of the personal residence 41-N and the advertisement support server 31 will be explained with reference to a flow chart.

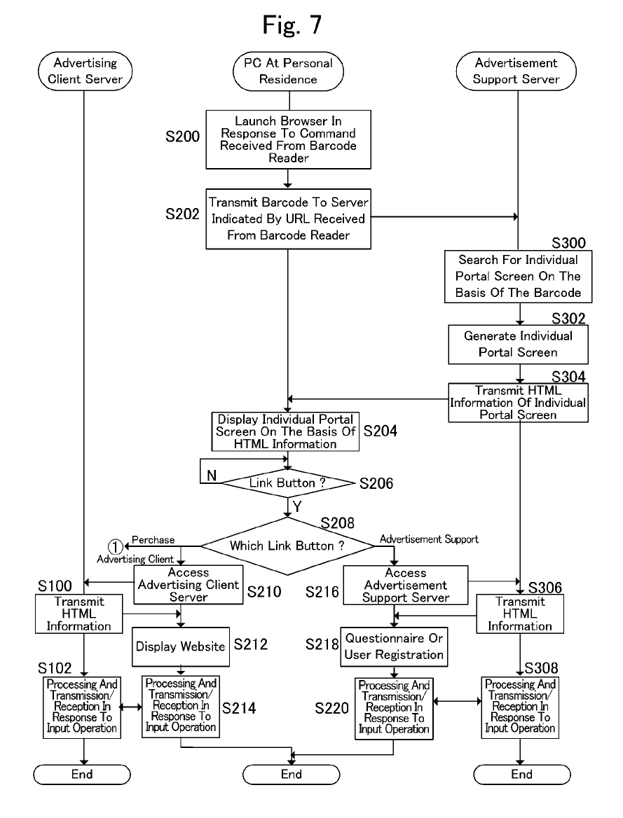

FIG. 7 is a flow chart showing an example of the communication procedure in accordance with the advertisement support system. Meanwhile, since the process as shown in FIG. 7 is performed by the use of well-known protocols such as TCP/IP (Transmission Control Protocol/Internet Protocol) and HTTP (HyperText Transfer Protocol), and therefore the details of the communication procedure will not be described.

Referring to FIG. 7, in step S200, the PC 43 of the personal residence 41-N launches a browser in response to the command given from the barcode reader 7. Then, in step S202, the PC 43 accesses the advertisement support server 31 on the basis of the URL given from the barcode reader 7, and transmits the URL (including the barcode information and the serial number 30) given from the barcode reader 7 to the advertisement support server 31. In this case, before the PC 43 receives the information, the barcode reader 7 performs the same steps similar to steps S1 to S11 of FIG. 3, and therefore no redundant description is repeated. Meanwhile, the ROM 19 of the barcode reader 7 stores the URL 27 of the advertisement support server 31.

The communication control unit 212 of the advertisement support server 31 receives the URL including the barcode information and the serial number 30. Then, in step S300, the first individual portal screen search unit 214 of the advertisement support server 31 accesses the first individual portal screen file 230, and searches this file for the URL (refer to FIG. 6(c)) which is associated with the barcode information as received.

In step S302, the individual portal screen generation unit 215 of the advertisement support server 31 generates HTML (HyperText Markup Language) information for enabling the PC 43 to display the first individual portal screen 100 including the link buttons corresponding to the URLs acquired in step S300. In step S304, the communication control unit 212 of the advertisement support server 31 transmits the generated HTML information to the PC 43 of the personal residence 41-N.

In this case, it is also possible to prepare an HTML information file for displaying the first individual portal screen 100 corresponding to each barcode information in advance, retrieve the HTML information file by searching HTML information files with the barcode information as an index, and transmits the retrieved one of the HTML information files to the PC 43.

The PC 43 receives the HTML information of the first individual portal screen 100, and displays the first individual portal screen 100 by parsing the HTML information in step S204. In step S206, the PC 43 determines whether or not any one of the link buttons 102, 104, 106, 108, 110, 112, 116 and 118 of the first individual portal screen 100 is pressed. If not pressed, the process is returned to step S206. If pressed, the process proceeds to step S208.

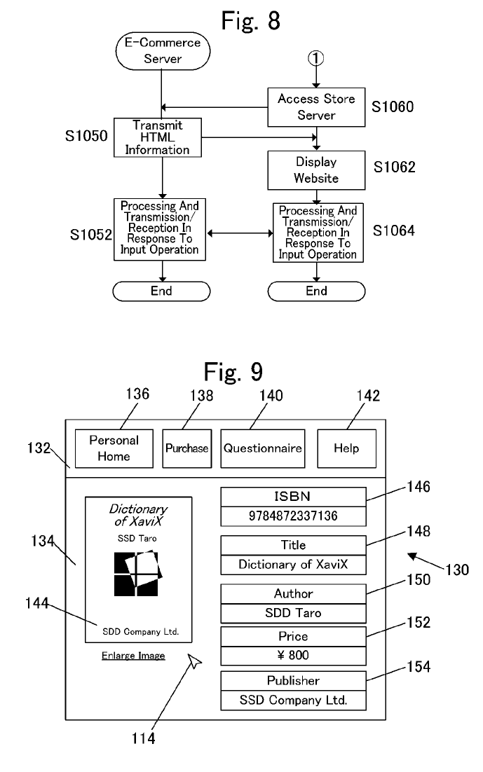

When the link button pressed in step S206 is any one of the link buttons 102, 106, 108, 116 and 118, the PC 43 proceeds to step S210 (from step S208). Conversely, when the link button pressed is either of the link buttons 110 and 112, the PC 43 proceed to step S216 (from step S208). Otherwise, when the link button pressed is the link button 104, the PC 43 proceeds to step S1060 of FIG. 8 (from step S208).

In step S210, the PC 43 accesses the server 47 of the advertising client 45-M on the basis of the URL corresponding to the link button which is pressed. The server 47 of the advertising client 45-M then transmits the corresponding HTML information to the PC 43 of the personal residence 41-N in step S100. The PC 43 receives and parses this HTML information, and display a website. In this case, when the link button pressed in step S206 is the link button 108, the website for explaining the commodity indicated by the barcode information transmitted in step S202 is displayed. When the link button as pressed is the link button 102, the home page of the advertising client 45-M of the commodity indicated by the barcode information is displayed. When the link button as pressed is the link button 106, the website for distributing the commercial message of the commodity indicated by the barcode information is displayed. When the link button pressed in step S206 is the link button 116, the website of the commodities which are related to the commodity indicated by the barcode information is displayed. When the link button as pressed is the link button 118, the website for the after-sales service of the commodity indicated by the barcode information is displayed.

In step S214, the PC 43 performs processing and communication with the server 47 of the advertising client 45-M in response to the input from the user. In step S102, the server 47 performs processing and communication with the PC 43 in response to the access from the PC 43.

On the other hand, in step S216, the PC 43 of the personal residence 41-N accesses the advertisement support server 31 on the basis of the URL corresponding to the link button as pressed. The communication control unit 212 of the advertisement support server 31 then transmits the corresponding HTML information to the PC 43 of the personal residence 41-N in step S306. In this case, when the link button pressed in step S206 is the link button 110, the user registration unit 216 of the advertisement support server 31 generates the HTML information of the website in which user registration can be done. Also, when the link button as pressed is the link button 112, the questionnaire aggregation unit 220 of the advertisement support server 31 generates the HTML information of the website in which a questionnaire can be conducted.

The PC 43 receives and parses the HTML information, and displays the website in step S218. In this case, when the link button pressed in step S206 is the link button 110, the website in which user registration can be done is displayed. Also, when the link button as pressed is the link button 112, the website in which a questionnaire can be conducted is displayed.

In step S220, the PC 43 performs processing and communication with the advertisement support server 31 in response to the input operation by the user. In step S308, the advertisement support server 31 performs processing and communication with the PC 43 in response to the access from the PC 43. In this case, when the link button pressed in step S206 is the link button 110, the user registration unit 216 of the advertisement support server 31 performs various processing for user registration, and stores the result of the processing in the user registration unit 216. Also, when the link button as pressed is the link button 112, the questionnaire aggregation unit 220 of the advertisement support server 31 performs various processing for collection and aggregation of questionnaire, and stores the result of the processing in the questionnaire file 260.

Referring to FIG. 8, when it is determined in step S206 of FIG. that the link button 104 is pressed, the PC 43 accesses an e-commerce server (not shown in the figure) of the business entity running an e-commerce site (i.e., a commodity purchase site) in step S1060 on the basis of the URL corresponding to the link button 104 which is pressed. This server then transmits the corresponding HTML information to the PC 43 in step S1050. In step S1062, the PC 43 receives and parses this HTML information, and displays the e-commerce site. In step S1064, the PC 43 performs processing and communication with the e-commerce server in response to the input operation by the user. In step S1052, this server performs processing and communication with the PC 43 in response to the access from the PC 43, and accepts the order for a commodity indicated by the barcode information. Incidentally, the electric configuration of this server is similar to that of the advertisement support server 31 shown in FIG. 6(a).

Next, the household account book generation unit 218 of the advertisement support server 31 will be explained. A household account book generation service is provided for the user who has made user registration and desires this service. The household account book generation unit 218 calculates daily household expenses and generates a household account book on the basis of the barcode information transmitted from the PC 43 of the user, and stores the generated household account book in the user registration file 240 in association with the user ID. In this case, while the name of the commodity is acquired from the barcode information, the price of the commodity is input to the PC 43 by the user and transmitted to the advertisement support server 31.

Incidentally, while the computer 37 and the monitor 39 of the store 35-K correspond to the PC 43 of the personal residence 41-N, the communication procedure among the server 47 of the advertising client 45-M, the computer 37 of the store 35-K and the advertisement support server 31 is performed in the same manner as shown in the flow charts of FIG. 7 and FIG. 8, and therefore no redundant description is repeated.

Meanwhile, the first individual portal screen 100 of FIG. 5(b) is an example of the individual portal screen. A first individual portal screen 130 will be explained as another example with reference to drawings.

FIG. 9 is a view for showing an example of the first individual portal screen 130 used in an application example 1. Referring to FIG. 9, this first individual portal screen 130 includes a frame 132 which is managed solely by the advertisement support corporation, and a frame 134 which is managed by the advertising client 45-M. Incidentally, while the advertising client 45-M manages the content in the frame 134, the system itself is managed by the advertisement support corporation. A cursor 114 is displayed in the first individual portal screen 130.

The frame 132 includes a personal home button 136, a purchase button 138, a questionnaire button 140, and a help button 142. The user can display a personal site by moving the cursor 114 to the personal home button 136, and clicking this button. This personal site is a website which is assigned to each user for displaying and managing the information specific to the each user. For example, the personal site is used to display the history of the barcodes 11 scanned by the user, manage the barcodes 11, and so forth. Meanwhile, the URL of the personal site is associated with the serial number 30 of the barcode reader 7 in a table which is stored in the HDD 56. Accordingly, the advertisement support server 31 can acquire the corresponding URL by referring to this table with the received serial number 30 as an index.

The user can display a commodity purchase site (i.e., an e-commerce site) by moving the cursor 114 to the purchase button 138, and clicking this button. This commodity purchase site is a site for performing the procedure of buying a commodity displayed in the frame 134, i.e., a commodity indicated by the barcode 11 which is scanned. The user can display a questionnaire site by moving the cursor 114 to the questionnaire button 140, and clicking this button. This questionnaire site is a site in which the user can input answers to a questionnaire. The user can display a help site by moving the cursor 114 to the help button 142, and clicking this button. This help site is a site for explaining in detail to the user the method of using the present system.

The frame 134 includes an image 144 of the commodity indicated by the scanned barcode 11, a barcode section 146 for displaying the barcode information indicated by the scanned barcode 11, and commodity information sections 148, 150, 152 and 154 for displaying various information items related to the commodity indicated by the scanned barcode 11. Each of the commodity information sections 148, 150, 152 and 154 includes an upper field (caption field) and a lower field (text field). In the example shown in FIG. 9, the commodity information section 148 is used to describe a caption (“Book Title”) and a text (“XaviX Dictionary”). The commodity information section 150 is used to describe a caption (“Author”) and a text (“Shinsedai Taro”). The commodity information section 152 is used to describe a caption (“Price”) and a text (“800 Yen”). The commodity information section 154 is used to describe a caption (“Publisher”) and a text (“SSD Company Limited”). In this example, these sections 148, 150 and 154 serve as link buttons. Accordingly, by moving the cursor 114 to any desired one of the commodity information sections 148, 150 and 154 and clicking this button, the user can browse a website for providing more detailed information about the information contained in the commodity information section which is clicked.

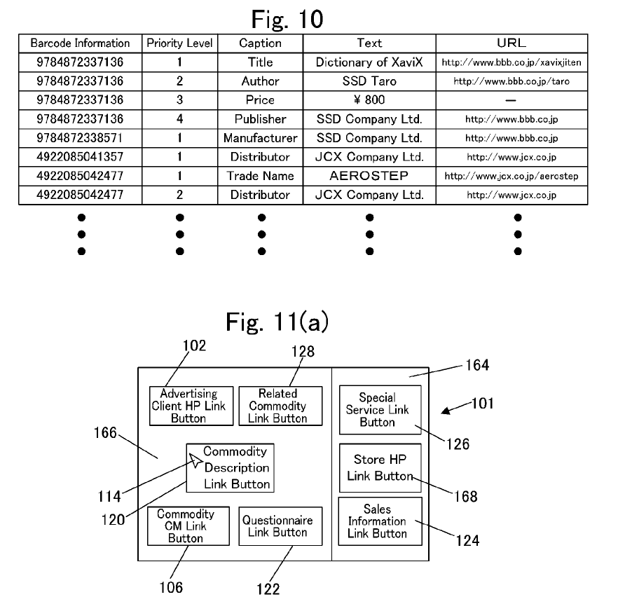

Next, the method of generating the first individual portal screen 130 by the advertisement support server 31 will be explained. The first individual portal screen 130 is generated with reference to an individual portal screen table shown in FIG. 10 and stored in the HDD 56.

Referring to FIG. 10, this table is a table in which each barcode is associated with a priority level, a caption, a text and a URL.

The “Priority Level” field in this table indicates a higher priority level by a smaller number. Then, the “Priority Level” field determines the priority levels of displaying the commodity information sections (148, 150, 152 and 154) respectively. A commodity information section having a higher priority level is displayed in a higher position in the frame 134. The “Caption” field contains a character string to be described in the upper field of each commodity information section. The “Text” field contains a character string to be described in the lower field of each commodity information section. The “URL” field contains the URL of the link target in the case where the corresponding commodity information section serves as a link button.

This will be explained in accordance with a specific example. The first through fourth lines of the table of FIG. 10 correspond to the commodity information sections 148, 150, 152 and 154 of FIG. 9 respectively. Priority levels are given to the commodity information sections 148, 150, 152 and 154 respectively in descending order. Accordingly, the commodity information sections 148, 150, 152 and 154 are displayed in this order from the above in the frame 134.

Of course, it can be arbitrarily determined by setting the content of this table how many commodity information sections are provided for one barcode 11, i.e., one first individual portal screen 130. In addition, the advertising client 45-M can freely determine what character strings are input to the “Caption” field and the “Text” field. Also, the advertising client 45-M can freely determine the priority levels in the “Priority Level” field. Furthermore, the advertising client 45-M can freely determine what URL is input to the “URL” field.

However, the advertisement support corporation permits displaying one commodity information section in the first individual portal screen 130 as a default, i.e., with no charge. In this case, the advertisement support corporation permits only describing a character string such as “Manufacturer”, “Retailer” or “Provider” in the “Caption” field, the name of company in the “Text” field and the URL of the home page of the company (the top page of the WEB site of the company, rather than the page of the commodity) in the “URL” field. The system may be designed such that the advertising client 45-M can determine the default settings of the commodity information section, that the advertisement support corporation can determine the default settings, or that both the advertising client 45-M and the advertisement support corporation can determine the default settings. However, it is not desirable that, despite scanning the barcode 11, no information is displayed for the corresponding commodity. It is assumed therefore that the advertisement support corporation determines the default settings of the commodity information section

at the outset. Also, the commodity information sections other than the default commodity information section is displayed as an option. The advertising client 45-M desiring the option is charged a fee and then permitted to set up the table.

In the case of the example shown in FIG. 10, with respect to the barcode information “9784872337136” and “4922085042477” in the table, the option has been selected such that four and two commodity information sections are displayed respectively. Also, with respect to the barcode information “9784872338571” and “4922085041357”, the option is not selected such that only one commodity information section is displayed as the default in which only the name of company is described.

Returning to FIG. 9, the barcode section 146 is located in a predetermined position to display the barcode information which is scanned. The position of the commodity image 144 is also determined in advance. However, the commodity image 144 is displayed in the first individual portal screen 130 only as an option, which incurs an extra fee.

Incidentally, the communication procedure of the advertisement support system for displaying the first individual portal screen 130 is the same as shown in FIG. 7 and FIG. 8. However, in step S300, the first individual portal screen search unit 214 of the advertisement support server 31 collects the information which is necessary for providing the first individual portal screen 130. In other words, the first individual portal screen search unit 214 accesses the individual portal screen table shown in FIG. 10, searches it by the use of the barcode information which is received, and retrieves the content of the commodity information sections. In addition to this, the first individual portal screen search unit 214 acquires the URL to be assigned to the personal home button 136 from the HDD 56 with reference to the received serial number 30 from the barcode reader 7 as an index. Meanwhile, the serial number of the barcode reader 7 is stored in the HDD 56 in association with the URL of the personal site of the user. Also, the first individual portal screen search unit 214 acquires the URL to be assigned to the purchase button 138 from the HDD 56 with reference to the received barcode information as an index. Incidentally, the barcode information is stored in the HDD 56 in association with the URL of the commodity purchase site. Furthermore, the first individual portal screen search unit 214 acquires the address, at which the commodity image 144 is stored, from the HDD 56 with reference to the received barcode information as an index. The barcode information is stored in the HDD 56 in association with the address information of the commodity image 144. The commodity image 144 is stored in the HDD 56.

In step S302, the individual portal screen generation unit 215 of the advertisement support server 31 generates HTML information for displaying the first individual portal screen 130 on the PC 43 on the basis of the information collected in step S300. Then, in step S304, the communication control unit 212 of the advertisement support server transmits the generated HTML information to the PC 43 of the personal residence 41-N.

As has been discussed above, in accordance with the application example 1 of the remote barcode reader system shown in FIG. 1, when the user who is interested in a commodity or has purchased a commodity scans the barcode by the barcode reader 7, the barcode information of the commodity is transmitted to the computer 37 installed in the store 35-K or the PC 43 installed in the personal residence 41-N (collectively referred to as “the terminal “tm” in the following description), and the terminal “tm” can receives information for generating the first individual portal screen 100 or 130 from the advertisement support server 31, and display the first individual portal screen 100 or 130.

Since each of the first individual portal screens 100 and 130 is a screen specific to the commodity indicated by the barcode information, it includes link information to the server 47 of the advertising client 45-M providing the information about the commodity. Accordingly, the user of the terminal “tm” accesses easily the server 47 of the advertising client 45-M of the commodity through the first individual portal screen 100 or 130, and can easily browse information about the desired commodity.

For the advertising client 45-M, there is an advantage that the information about a commodity can be provided to the individual who is actually interested in the commodity or has purchased the commodity with pinpoint accuracy through the first individual portal screen 100 or 130. In this regard, this system substantially differs from the conventional affiliate program.

On the other hand, for the user of the terminal “tm”, for example, when the user becomes interested in a commodity or wants to search some information about a purchased commodity, it is possible to display the first individual portal screen 100 or 130 which is specific to the commodity on the monitor of the terminal “tm” only by scanning the barcode of the commodity with the barcode reader 7 and transmitting the barcode information with the terminal “tm”. The user can therefore easily access the target site through the first individual portal screen 100 or 130. Because of this, it becomes much easier to acquire the information about the commodity as compared with the case where the information about the commodity is acquired by inputting terms, which seem to be related to the commodity, to a general purpose search engine, or by making use of a conventional portal site and searching for the information about the desired commodity among a number of commodities which are classified in a structured manner.

Also, when making use of a conventional technique such as a general purpose search engine or portal site service, such a situation may arise that the user cannot find which information is the information he wants from among a number of commodity sites having the equivalent or similar titles in the search results obtained by the conventional technique. However, such a situation can be avoided in accordance with the above system. Furthermore, in accordance with these conventional techniques, the search results often include misleading sites and informal sites, which become a hindrance when the advertising client 45-M wants website audience accessing the server 47 thereof. However, such a situation can be avoided also in accordance with the above system.

The advertisement support corporation running the advertisement support server 31 can make a profit from the business entity operating the advertising client 45-M or the store 35-K when preparing the first individual portal screen 100 or 130. For example, while charging no fee for the first individual portal screen 100 or 130 in which only the link button 102 of the home page of the advertising client 45-M is displayed, a certain fee is charged to the advertising client 45-M who desires to display more link information items in the first individual portal screen 100 or 130. The link information items increase in the first individual portal screen 100 or 130 in this manner.

If many link information items are displayed in the first individual portal screen 100 or 130, the corresponding commodity can be advertised from a variety of angles, and thereby the users are more encouraged to buy the commodity than when a fewer link information items are displayed in the first individual portal screen 100 or 130. In other words, when comparing similar commodities, the sales total of commodity products of the advertising client having the first individual portal screen 100 or 130 containing many link information items is expected to be larger than the sales total of commodity products of the advertising client having the first individual portal screen 100 containing a fewer link information items. Accordingly, the advertising client 45-M is expected to desire to display extra link information items even if it requires paying a fee.

For the same reason, it is apparent that a difference occurs in sales between the store 35-K such as a retail store with the present system installed, and another store without the present system. Accordingly, most business entities operating stores are also expected to introduce the present system. In this case, the advertisement support corporation can make profits by charging the business entities operating the respective stores 35-K.

Of course, the advertisement support server 31 could provide the PC 43 or the computer 37 with the URL of the website of the commodity indicated by the barcode information in place of the first individual portal screen 100 or 130, and enable the PC 43 or the computer 37 to directly display the website. However, in this case, there is no advantages as has been described above and specific to the first individual portal screen 100 or 130.

Also, the link button 104 or 138 corresponding to the URL of the commodity purchase site which is run by an e-commerce business entity is displayed in the first individual portal screen 100 or 130. Accordingly, since the commodity can be sold through these buttons 104 and 138, the advertisement support corporation running the first individual portal screen 100 or 130 can make profits by affiliate advertising.

### APPLICATION EXAMPLE 2

The advertisement support server 31 provides different content items between the individual portal screen displayed on the PC 43 of the personal residence 41-N from which the user accesses the advertisement support server 31 and the individual portal screen displayed on the computer 37 of the store 35-K from which the user accesses the advertisement support server 31, even though the same barcode is scanned.

In the case where the user accesses the advertisement support server 31 from the computer 37 of the store 35-K, it is considered that the user has been mulling over buying, and thereby the individual portal screen is designed to include many links to information which enhances buying motivation such as commodity commercial. On the other hand, in the case where the user accesses the advertisement support server 31 from the PC 43, it is considered that the user often has already purchased the commodity, and thereby the individual portal screen is designed to include many links to information about a new type of the commodity, information for after-purchase service and the like information. The individual portal screen can therefore be designed to meet the needs of advertising clients and users as much as possible. In this manner, even if the same barcode is scanned, the individual portal screen is provided with a different design depending upon in which step the user is when purchasing the commodity. In the case of the application example 2, the installation location of the terminal “tm” is used to determine in which step the user is when purchasing the commodity.

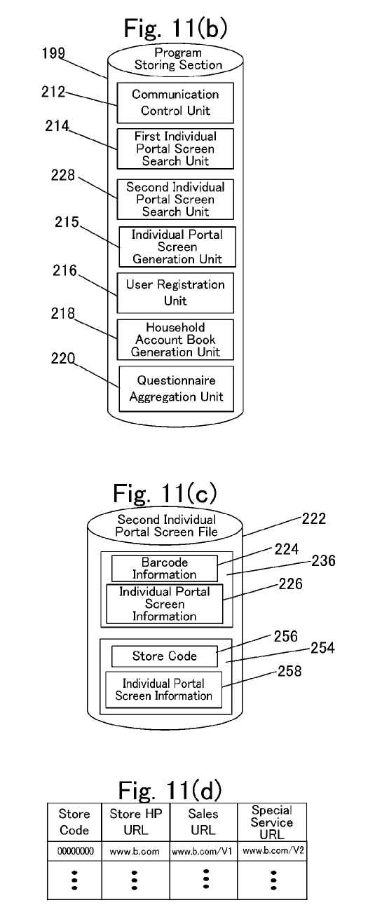

More specifically speaking, in the case of the application example 2, the first individual portal screen 100 shown in FIG. 5(b) is displayed on the PC 43 when the user accesses the advertisement support server 31 from the PC 43. On the other hand, when the user accesses the advertisement support server 31 from the computer 37 of the store 35-K, a second individual portal screen 101 shown in FIG. 11(a) is displayed on the monitor 39.

Referring to FIG. 11(a), the second individual portal screen 101 includes a frame 166 containing links to content items which are managed by the advertising client 45-M, and a frame 164 containing links to content items which are managed by the store central office 75-P.

The frame 166 includes a link button 102 for opening the home page (HP) of the advertising client 45-M of the commodity indicated by barcode information, a link button 128 for opening a website in which related commodities of the commodity indicated by the barcode information are described, a link button 106 for opening a website in which a commercial message (CM) of the commodity indicated by the barcode information is distributed, a link button 120 for opening a website in which commodity description is given for the commodity indicated by the barcode information, and a link button 112 for opening a website in which a questionnaire can be conducted for the commodity indicated by the barcode information. The frame 164 includes a link button 124 providing a link to a website describing information for sales of the store 35-K, a link button 126 providing a link to a website describing special services of the store 35-K, and a link button 168 for opening the home page (HP) of the store central office 75-P. Furthermore, the cursor 114 is displayed on the second individual portal screen 101.

However, as a default link buttons (for which the advertising client 45-M is not charged), only the link button 102 for opening the home page of the advertising client 45-M, and a link button 122 for opening the website in which the questionnaire can be conducted, are displayed. The other link buttons 128, 106 and 120 are displayed only after the advertising client 45-M becomes a member of the advertisement support system of the business entity running the advertisement support server 31. Furthermore, the link buttons 124, 126 and 168 are displayed only after the store central office 75-P becomes a member of the advertisement support system of the business entity running the advertisement support server 31.

The common points and different points between the first individual portal screen 100 and the second individual portal screen 101 of the application example 2 will be explained. First, the common points will be explained. The link button 102 and 106 are the same in both sides. This is because there is little reason to differentiate these content items between the personal residence 41-N and the store 35-K.

Next, the different points will be explained. The link button 108 of the first individual portal screen 100 is different from the link button 120 of the second individual portal screen 101. For example, while the link button 108 serves as a link to a site showing how to use the commodity or application examples because the user is viewing it in the personal residence 41-N, the link button 120 serves as a link to a site describing explanation which can enhance buying motivation in addition to explanation of how to use because the user is viewing it in the store 35-K and thereby expected to be considering purchasing in a proactive manner.

Also, the link button 116 of the first individual portal screen 100 is different from the link button 128 of the second individual portal screen 101. For example, while the link button 116 serves as a link to a site describing not only how to use the commodity or application examples, but also information about model changes and new products because the user is viewing it in the personal residence 41-N and thereby he is expected to have already possessed the commodity. Also, the link button 128 serves as a link to a site showing other items belonging to the same category which are manufactured and sold by the advertising client 45-M in order to expand the range of options to purchase, because the user is viewing it in the store 35-K.

Furthermore, the link button 112 of the first individual portal screen 100 is different from the link button 122 of the second individual portal screen 101. This is because there may be differences between the store 35-K and the personal residence 41-N, in regard to the mental state of the user and the proportion of the number of users who already have purchased (or have not purchased yet), and thereby some significant information could be acquired by conducting different questionnaires.

Meanwhile, the link button 104 is displayed only in the first individual portal screen 100 which is viewed at the personal residence 41-N, but not displayed in the second individual portal screen 101. This is because, while it is expected to purchase through an e-commerce service at the personal residence 41-N, it is expected to purchase directly at the store 35-K and thereby the link button 104 is not needed in the second individual portal screen 101.

Meanwhile, the link button 118 is displayed only in the first individual portal screen 100 which is viewed at the personal residence 41-N, but not displayed in the second individual portal screen 101. This is because, while it is expected that the user at the store 35-K has not purchased the commodity yet, the user may at the personal residence 41-N have already purchased the commodity so that after-sales service is often needed.

Meanwhile, the link button 110 is displayed only in the first individual portal screen 100 which is viewed at the personal residence 41-N, but not displayed in the second individual portal screen 101. This is because it is unlikely that the user makes user registration at the store 35-K, but usually the user makes user registration at the personal residence 41-N.

Meanwhile, the link buttons 124, 126 and 168 are displayed only in the second individual portal screen 101, but not displayed in the first individual portal screen 100. This is because the link buttons 124, 126 and 168 are provided for information related to the store 35-k, and the PC 43 of the personal residence 41-N does not have the information of the store 35-K. Incidentally, the system configuration of this application example 2 is similar to the system configuration shown in FIG. 4. However, the barcode reader 7 of the store 35-K is a barcode reader which is commercially available in the marketplace, rather than the barcode reader having the configuration shown in FIG. 2 which is specific to the present invention. Incidentally, the computer 37 of the store 35-K is provided with dedicated software preinstalled therein for transmitting the barcode 11 through a browser to the advertisement support server 31. In this case, this dedicated software is automatically launched in response to the input of the barcode 11, and automatically transmits the barcode 11 to the advertisement support server 31.

Meanwhile, even in the case where such preinstalled dedicated software is used, it is substantially not needed to take troublesome installation into consideration at the store 35-K, unlike at the personal residence 41-N. This is because, in the case of the store 35-K, the computer 37, the monitor 39 and the barcode reader 7 is set up by the entity in many cases.

Also, the programs and data segments are stored in the storage area 200 of the advertisement support server 31 in the same fashion as illustrated in FIG. 6(b). However, a program storing section 199 shown in FIG. 11(b) is used in place of the program storing section 210. Particularly, the storage area 200 is used to store a second individual portal screen file 222 as shown in FIG. 11(c) in addition to the first individual portal screen file 230.

Referring to FIG. 11(b), the program storing section 199 is provided with a second individual portal screen search unit 228 in addition to the configuration of the program storing section 210. The second individual portal screen file 222 of FIG. 11(c) includes an advertising client file 236 and a store file 254. The advertising client file 236 is provided to form a database for storing barcode information 224 provided individually for each item of commodity, and individual portal screen information 226 corresponding to each item of commodity indicated by the barcode information 224 in association with each other. The store file 254 is provided to form a database for storing store codes 256 which are assigned to the stores 35-K respectively, and individual portal screen information 258 in association with each other.

Referring to FIG. 11(d), the store file 254 is a file in which the store codes 256 are stored in association with the individual portal screen information 258. The individual portal screen information 258 contains the URL of the home page of the store central office corresponding to the link button 168 of FIG. 11(a), the URL of the special service information site corresponding to the link button 126, and the URL of the sales information site corresponding to the link button 124.

Referring to FIG. 11(e), the advertising client file 236 is a file in which, for each commodity, the barcode information 224 is associated with the individual portal screen information 226. The individual portal screen information 226 contains the URL of the home page of the advertising client corresponding to the link button 102 of FIG. 11(a), the URL of the related commodity site corresponding to the link button 128, the URL of the commercial message site corresponding to the link button 106, the URL of the commodity description site corresponding to the link button 120, the URL of the questionnaire site corresponding to the link button 122. Incidentally, the protocol indication (“http://”) is omitted in FIG. 11(d) and FIG. 11(e).

Meanwhile, the communication procedure among the server 47 of the advertising client 45-M, the PC 43 of the personal residence 41-N and the advertisement support server 31 is performed in the advertisement support system of the application example 2 in the same manner as shown in the flow charts of FIG. 7 and FIG. 8. Nevertheless, there are different points which will be explained sequentially in the following description.

Referring to FIG. 7, in step S202, the PC 43 of the personal residence 41-N transmits to the advertisement support server 31 the URL (for example, “http://www.ssd.co.jp/house/” in which the barcode information and the serial number are omitted herein for the sake of clarity in description) which is different from the URL (for example, “http://www.ssd.co.jp/kiosk/” in which the barcode information and the serial number are omitted herein for the sake of clarity in description) which is transmitted by the dedicated software installed in the computer 37 of the store 35-K. Namely, the URL transmitted to the PC 43 by the barcode reader 7 of the personal residence 41-N is different from the URL transmitted by the dedicated software installed in the computer 37 of the store 35-K. As described above, for example, different directory names are concatenated just after the domain name between the personal residence 41-N and the store 35-K. Alternatively, for example, it is possible to provide different subdomains therebetween. In brief, any known technique can be used as long as the advertisement support server 31 can distinguish between the personal residence 41-N and the store 35-K. The dedicated software of the computer 37 transmits also the store code assigned to the store 35-K, to the advertisement support server 31.

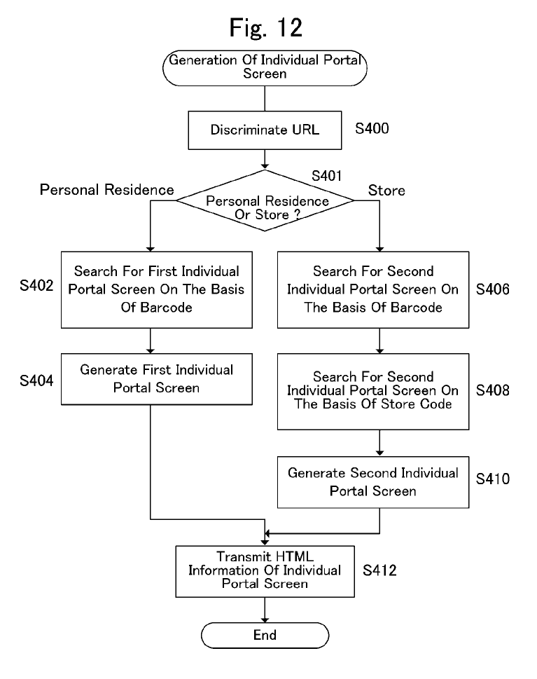

Furthermore, in the case of the application example 2, the process of generating the individual portal screen as shown in FIG. 12 is performed in place of steps S300, S302 and S304 of FIG. 7.

Referring to FIG. 12, in step S400, the communication control unit 212 of the advertisement support server 31 confirms the content of the URL which is received, and determines which of the personal residence 41-N and the store 35-K transmits the received URL. In step S401, when the received URL is transmitted from the PC 43 of the personal residence 41-N, i.e., if the directory name concatenated just after the domain name is “house” in the aforementioned example, the communication control unit 212 proceeds to step S402 by giving control to the first individual portal screen search unit 214. Conversely, when the received URL is transmitted from the computer 37 of the store 35-K, i.e., if the directory name concatenated just after the domain name is “kiosk” in the aforementioned example, the communication control unit 212 proceeds to step S406 by giving control to the second individual portal screen search unit 228.

In step S402, the first individual portal screen search unit 214 accesses the first individual portal screen file 230, and searches for the URL (refer to FIG. 6(c)) associated with the barcode information which is received. Then, in step S404, the individual portal screen generation unit 215 generates HTML (HyperText Markup Language) information for enabling the PC 43 of the personal residence 41-N to display the first individual portal screen 100 including the link buttons corresponding to the URLs acquired in step S402.

On the other hand, in step S406, the second individual portal screen search unit 228 accesses the advertising client file 236 of the second individual portal screen file 222, and searches for the URL (refer to FIG. 11(e)) associated with the barcode information which is received. Furthermore, in step S408, the second individual portal screen search unit 228 accesses the store file 254 of the second individual portal screen file 222, and searches for the URLs (refer to FIG. 11(d)) which are associated with the store code which is received. Then, in step S410, the individual portal screen generation unit 215 generates HTML information for enabling the computer 37 of the store 35-K to display the second individual portal screen 101 including the link buttons corresponding to the URLs acquired in steps S406 and S408.

In step S412 after step S404, the communication control unit 212 of the advertisement support server 31 transmits the HTML information generated in step S404 to the PC 43 of the personal residence 41-N. On the other hand, in step S412 after step S410, the communication control unit 212 transmits the HTML information generated in step S410 to the computer 37 of the store 35-K.

Next is a description of explaining the communication procedure among the server 47 of the advertising client 45-M, the computer 37 of the store 35-K, and the advertisement support server 31 in the case of the application example 2.

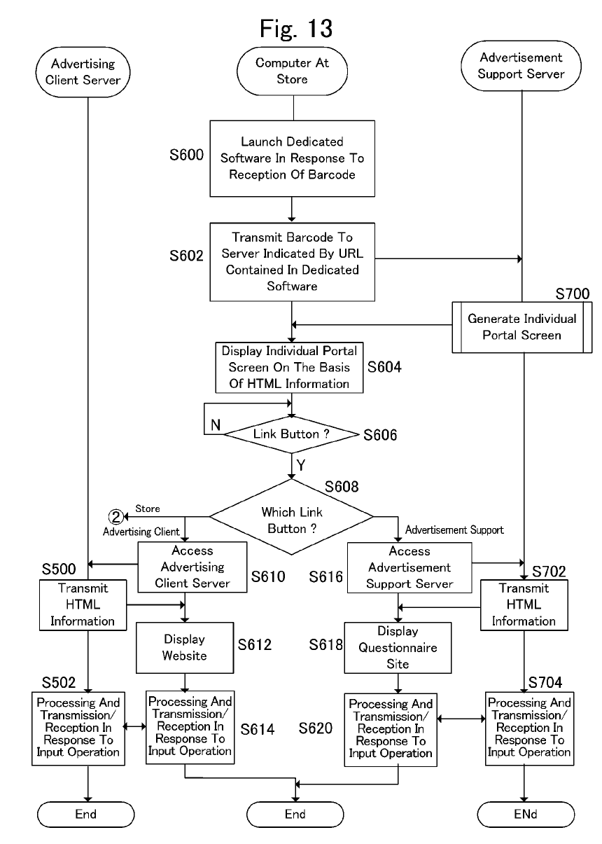

FIG. 13 is a flow chart for showing an example of the communication procedure among the server 47 of the advertising client 45-M, the computer 37 of the store 35-K, and the advertisement support server 31 in the case of the application example 2. Incidentally, in FIG. 13, the details of the communication procedure of the above processing is dispensed with because these steps are performed by well-known protocols, such as TCP/IP (Transmission Control Protocol/Internet Protocol), HTTP (HyperText Transfer Protocol) and so forth.

Referring to FIG. 13, in step S600, the computer 37 of the store 35-K launches the dedicated software as described above when the barcode information is given from the barcode reader. In step S602, then, the dedicated software transmits the barcode information and the store code contained therein to the advertisement support server 31 on the basis of the URL contained therein of the advertisement support server 31. Incidentally, this barcode reader is an ordinary barcode reader which provides the computer 37 with only the barcode information as keyboard data, unlike the barcode reader 7. Incidentally, the dedicated software saves the URL of the advertisement support server 31 and the store code, for example, by storing them in the HDD of the computer 37.

The communication control unit 212 of the advertisement support server 31 receives this barcode information and the store code. In step S700, then, the advertisement support server 31 performs the process of generating the individual portal screen as shown in FIG. 12.

The computer 37 of the store 35-K receives the HTML information of the second individual portal screen 101, and parses the HTML information to display the second individual portal screen 101 in step S604. In step S606, the computer 37 determines whether or not any one of the link buttons 102, 128, 120, 106, 122, 126, 168 and 124 is pressed in the second individual portal screen 101. If none of the link buttons is pressed, the process is returned to step S606, but if any one of these link buttons is pressed, the process proceeds to step S608.

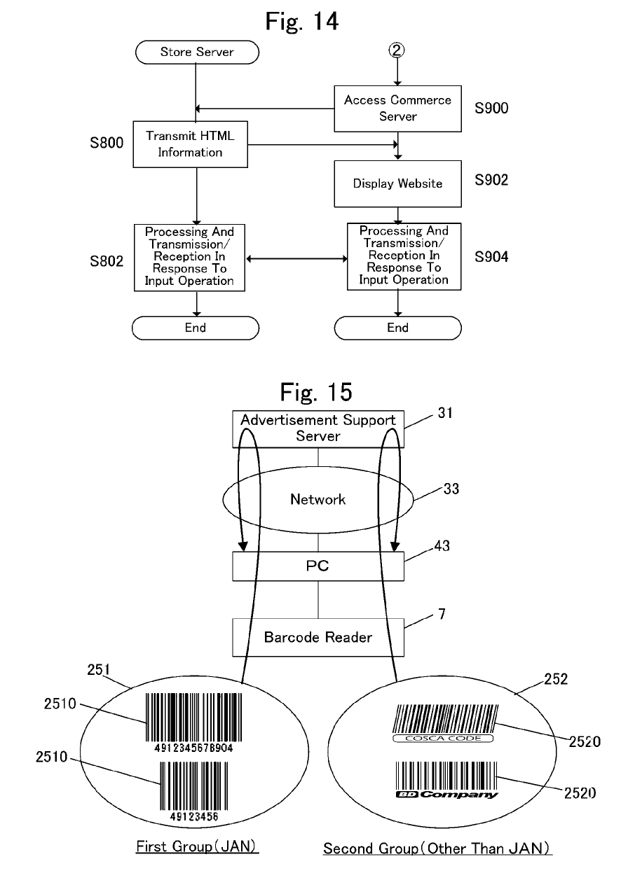

When the link button pressed in step S606 is any one of the link buttons 102, 128, 120 and 106, the computer 37 proceeds to step S610 (from step S608). Conversely, when the link button pressed is the link button 122, the computer 37 proceeds to step S616 (from step S608). Otherwise, when the link button pressed is any one of the link buttons 126, 168 and 124, the computer 37 proceeds to step S900 of FIG. 14 (from step S608).

In step S610, the computer 37 accesses the server 47 of the advertising client 45-M on the basis of the URL corresponding to the link button which is pressed. The server 47 of the advertising client 45-M then transmits the corresponding HTML information to the computer 37 of the store 35-K in step S500. In step S612, then, the computer 37 receives and parses this HTML information, and display a website. In this case, when the link button pressed in step S606 is the link button 120, the website for explaining the commodity indicated by the barcode information transmitted in step S602 is displayed. When the link button as pressed is the link button 102, the home page of the advertising client 45-M of the commodity indicated by the barcode information is displayed. When the link button as pressed is the link button 106, the website for distributing the commercial message of the commodity indicated by the barcode information is displayed. When the link button pressed in step S606 is the link button 128, the website of the commodities which are related to the commodity indicated by the barcode information is displayed.

In step S614, the computer 37 performs processing and communication with the server 47 of the advertising client 45-M in response to the input from the user. In step S502, the server 47 performs processing and communication with the computer 37 in response to the access from the computer 37.

On the other hand, in step S616, the computer 37 accesses the advertisement support server 31 on the basis of the URL corresponding to the link button 122 as pressed. The communication control unit 212 of the advertisement support server 31 then transmits the corresponding HTML information to the computer 37 of the store 35-K in step S702. In this case, the questionnaire aggregation unit 220 of the advertisement support server 31 generates the HTML information of the website in which a questionnaire can be conducted.

The computer 37 receives and parses the HTML information, and displays the website in which a questionnaire can be conducted in step S618.

In step S620, the computer 37 performs processing and communication with the advertisement support server 31 in response to the input operation by the user. In step S704, the advertisement support server 31 performs processing and communication with the computer 37 in response to the access from the computer 37. In this case, the questionnaire aggregation unit 220 of the advertisement support server 31 performs various processing for collection and aggregation of the questionnaire, and stores the result of the processing in the questionnaire file 260.

Referring to FIG. 14, when it is determined in step S608 of FIG. 13 that any one of the link buttons 126, 168 and 124 is pressed, the computer 37 accesses the server 77 of the store central office 75-P in step S900 on the basis of the URL corresponding to the link button which is pressed. This server 77 then transmits the corresponding HTML information to the computer 37 of the store 35-K in step S800. In step S902, then, the computer 37 receives and parses this HTML information, and displays a website. In this case, the computer 37 displays a website describing special services of the store 35-K indicated by the store code which is transmitted in step S602 when the link button pressed in step S606 is the link button 126, displays the home page of the store central office 75-P which manages the store 35-K indicated by the store code when the link button pressed is the link button 168, and displays a website describing information for sales of the store 35-K indicated by the store code when the link button pressed is the link button 124.

In step S904, the computer 37 performs processing and communication with the server 77 of the store central office 75-P in response to the input operation by the user. In step S802, the server performs processing and communication with the computer 37 in response to the access from the computer 37.

Meanwhile, in the case of the application example 2, the first individual portal screen 130 shown in FIG. 9 can be displayed in place of the first individual portal screen 100.

Incidentally, in accordance with the application example 2 as has been discussed above, since the advertisement support server 31 can perform processing by taking into consideration the mental state of the user and in which step the user is when purchasing the commodity (for example, after or before purchasing, away from home or at home), it is possible to effectively provide services and content by taking into consideration the mental state of the user and in which step the user is when purchasing the commodity. This is because differences in the installation locations of the communication terminals (37, 43), i.e., the locations the users stay, may result in differences in regard to the mental state of the user and in which step the user is when purchasing the commodity.

### APPLICATION EXAMPLE 3

The system configuration of the application example 3 is similar to the system configuration shown in FIG. 4. In what follows, this example will be explained by focusing on its characterizing points with reference to drawings.

FIG. 15 is an explanatory view for showing the application example 3. Referring to FIG. 15, in the case of the application example 3, the advertisement support server 31 performs processing by classifying the barcodes into a first group 251 and a second group 252. The first group 251 includes barcodes each of which consists of a 13-digit or 8-digit JAN (Japanese Article Number) code 2510, and the second group 252 includes barcodes each of which consists of a barcode 2520 which is not a JAN code.

The JAN code is a common product code (a common code is assigned to the same commodity items) used in Japan, and has been applied typically to POS (Point Of Sale) systems, also applied to ordering systems, inventory clearance systems and inventory control systems, and further applied to payment systems for public utility charges and so forth. The first group 251 corresponds to the eleventh example as described above. On the other hand, the barcode 2520 of the second group is, for example, a 14-digit barcode which is issued by the advertisement support corporation in correspondence with each service or content item thereof. The second group 252 corresponds to the first to tenth examples as described above. When setting a plurality of groups into which barcodes are classified in this manner, 14-digit barcodes are issued to belong respectively to the groups in correspondence with the respective services and content items without overlapping between groups.

In the case of the application example 3, the advertisement support server 31 determines the number of digits of the barcode which is received from the PC 43, and determines which the received barcode is the barcode 2510 (i.e., a JAN code) belonging to the first group 251 or the barcode 2520 belonging to the second group 252. In this case, the advertisement support server 31 determines that the barcode belongs to the first group 251 if the number of digits of the received barcode is 13 or 8, and otherwise the barcode belongs to the second group 252.

Then, if the received barcode is the barcode 2510 belonging to the first group 251, the advertisement support server 31 transmits the first individual portal screen 100 (needless to say, the first individual portal screen 130 may be transmitted instead) to the PC 43. On the other hand, if the received barcode is the barcode 2520 belonging to the second group 252, the advertisement support server 31 performs processing in accordance with the group to which the barcode 2520 belongs, generates content in accordance with this group and in correspondence with the barcode 2520, and transmits the content to the PC 43.

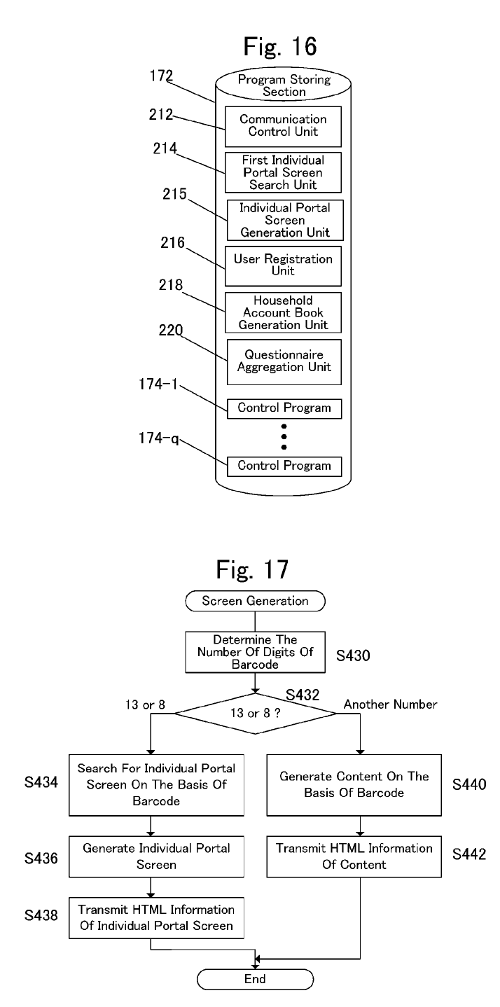

Incidentally, the programs and data segments are stored in the storage area 200 of the advertisement support server 31 in the same fashion as illustrated in FIG. 6(b). However, a program storing section 172 shown in FIG. 16 is used in place of the program storing section 210. The program storing section 172 is provided with control programs 174-1 to 174-q in addition to the configuration of the program storing section 210. The control programs 174-1 to 174-q are collectively referred to as the control programs 174-Q.

The 14-digit barcodes other than JAN codes are classified into a plurality of groups. These groups are associated with various services in a one-to-one correspondence. The PC 43 is then provided with the content in correspondence with the group to which the received 14-digit barcode belongs. In this case, the content is generated by running the control program 174-Q corresponding to this group. Accordingly, each group is provided with the control program 174-Q corresponding thereto. Of course, the storage area 200 is also used to store the resources which are used by each control program 174-Q in addition to those illustrated in the figure.

Meanwhile, the communication procedure among the server 47 of the advertising client 45-M, the PC 43 of the personal residence 41-N and the advertisement support server 31 is performed in the advertisement support system of the application example 3 in the same manner as shown in the flow chart of FIG. 7. Nevertheless, there are different points which will be explained sequentially in the following description.

In the case of the application example 3, the process of generating the screen as shown in FIG. 17 is performed in place of steps S300, S302 and S304 of FIG. 7.

Referring to FIG. 17, the communication control unit 212 of the advertisement support server 31 determines the number of digits of the received barcode information in step S430. In step S432, then, when the number of digits of the received barcode is 13 or 8, i.e., when a JAN code is received, the communication control unit 212 proceeds to step S434 by giving control to the first individual portal screen search unit 214. Conversely, when the number of digits of the received barcode is not 13 nor 8, the process proceeds to step S440 by giving control to the control program 174-Q corresponding to the group to which the barcode information belongs.

In step S434, the first individual portal screen search unit 214 accesses the first individual portal screen file 230, and searches this file for the URLs (refer to FIG. 6(c)) which are associated with the barcode information as received. In step S436, then, the individual portal screen generation unit 215 generates HTML information for enabling the PC 43 of the personal residence 41-N to display the first individual portal screen 100 including the link buttons corresponding to the URLs acquired in step S434. In step S438, the communication control unit 212 of the advertisement support server 31 transmits the HTML information generated in step S436 to the PC 43 of the personal residence 41-N.

On the other hand, in step S440, the control program 174-Q generates HTML information of the content corresponding to the generated barcode information. In step S442, then, the communication control unit 212 of the advertisement support server 31 transmits the HTML information generated in step S440 to the PC 43 of the personal residence 41-N.

Incidentally, while the computer 37 of the store 35-K correspond to the PC 43 of the personal residence 41-N, the communication procedure of the application example 3 among the advertisement support server 31, the computer 37 and the advertising client 45-M is performed in the same manner as the communication procedure among the advertisement support server 31, the PC 43 and the advertising client 45-M, and therefore no redundant description is repeated.

By the way, in the case of the application example 3 as has been discussed above, the advertisement support server 31 classifies a barcodes as received into either the first group 251 or the second group 252, and processing is performed in accordance with the result of classification. The first group 251 includes the JAN code 2510 which is originally designed for use in the POS system rather than for use in the present system. In other words, the JAN codes 2510 are provided independently of the present system, and widely distributed in the world. Accordingly, the present system provides services, i.e., individual portal screens by the use of the JAN code 2510 which has been widely distributed in the world. On the other hand, while the second group 252 includes the barcodes 2520 other than the JAN code 2510, the barcodes 2520 are designed for the purpose of providing a particular service by the use of the present system, but not designed for use in the POS system. Namely, the barcodes 2520 are provided for use in the present system. Accordingly, a variety of services are provided by the present system in accordance with the purpose of preparing the barcodes 2520.

As discussed above, while the barcode 2510 belonging to the first group 251 is different from the barcode 2520 belonging to the second group 252 in nature and feature, the user can scan these barcodes by the use of the same barcode reader 7 without awareness of this fact, and receive the service provided in accordance with the first group 251 and a variety of services in accordance with the various barcodes 2520 belonging to the second group 252.

In addition, the user can easily obtain a good to which the JAN code 2510 having been widely distributed is attached, and the present system can readily be available only with the barcode reader 7 on the assumption that an appropriate network environment has been established. On the other hand, the user can receive a wide variety of different services by scanning the barcode 2520 belonging to the second group 252.

Furthermore, on the system installation side, since the JAN code 2510 having been widely distributed can be used, it requires smaller labor as compared with the case where only the barcodes 2520 are used.

### APPLICATION EXAMPLE 4

The application example 4 makes use of a camera unit 180 in place of the barcode reader 7 shown in FIG. 4. In what follows, this example will be explained by focussing on its characterizing points with reference to drawings.

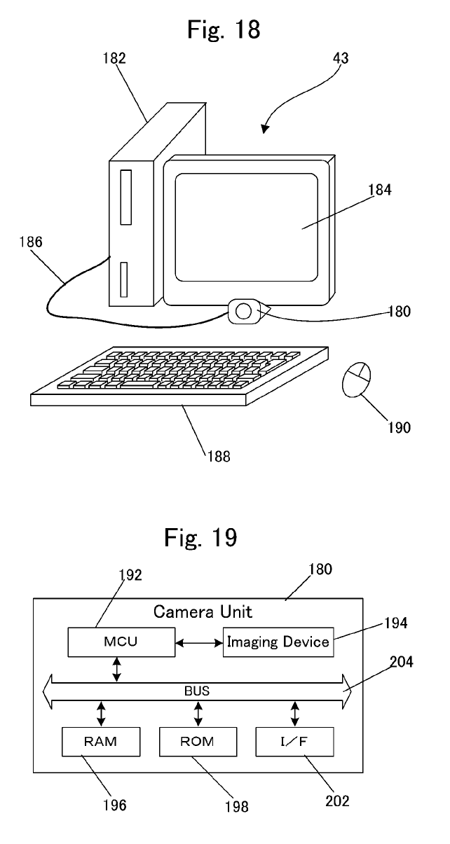

FIG. 18 is a perspective external view for showing the PC 43 and the camera unit 180 installed in the personal residence 41-N. Referring to FIG. 18, the PC 43 includes a computer unit 182, a monitor 184, a wireless keyboard 188 and a wireless mouse 190. The camera unit 180 is connected to the computer unit 182 of the PC 43 by a USB (Universal Serial Bus) cable 186. The camera unit 180 is located below the monitor 184. However, the camera unit 180 can be placed in an arbitrary location, such as on the top of the monitor 184.

When the camera unit 180 is connected to the PC 43, the PC 43 recognizes the camera unit 180 as a keyboard and a mouse. The camera unit 180 takes an image of the barcode 11 attached to a commodity produce which is held by the user over the camera unit 180. Then, the camera unit 180 analyzes the image which is taken, numerically converts the barcode 11 into keyboard data and outputs this data to the PC 43. The barcode which is numerically converted is called barcode information. This camera unit 180 serves also as a mouse (pointing device) at the same time. Namely, when the user holds the commodity product over the camera unit 180, and moves the commodity product itself, the camera unit 180 calculates the amounts of moving the commodity product (in both the X-axis and the Y-axis), and outputs them to the PC 43. The PC 43 moves the cursor 114 displayed in the individual portal screen in accordance with the amounts of motion as received. In other words, the cursor 114 is moved in synchronization with the motion of the commodity product. Also, the camera unit 180 successively calculates the area of the image of the commodity product which is taken. When the area of the image increases by a predetermined factor or more, i.e., when the commodity product substantially approaches the camera unit 180, the camera unit 180 recognizes this motion as the gesture of clicking and transmits clicking information to the PC 43. Accordingly, when receiving the clicking information from the camera unit 180 while the cursor 114 is located in a link button of the individual portal screen, the PC 43 determines that the link button is pressed.

FIG. 19 is a schematic diagram for showing the electric configuration of the camera unit 180 as shown in FIG. 18. Referring to FIG. 19, the camera unit 180 includes an MCU (Microcontroller Unit) 192, an imaging device 194 such as a CCD or an image sensor, a RAM 196, a ROM 198, an interface (I/F) 202 and a bus 204. The MCU 192 is connected to the RAM 196, the ROM 198 and the I/F 202 through the bus 204. The imaging device 194 is, for example, a VGA (Video Graphics Array) compatible device. Also, the I/F 202 includes a USB controller. The ROM 198 is used to store a control program to be described below with reference to a flow chart. The RAM 196 is used as a storage area for storing image data transmitted from the imaging device 194, a working area and so forth.

The communication procedure among the server 47 of the advertising client 45-M, the PC 43 of the personal residence 41-N and the advertisement support server 31 is performed in the advertisement support system of the application example 4 in the same manner as shown in the flow chart of FIG. 7.

In addition, the camera unit 180 can be used in place of the barcode reader 7 of the store 35-K. Also, the communication procedure among the server 47 of the advertising client 45-M, the computer 37 of the store 35-K and the advertisement support server 31 is performed in the advertisement support system of the application example 4 in the same manner as shown in the flow chart of FIG. 7.

Next, the process performed by the MCU 192 will be explained with reference to a flow chart.

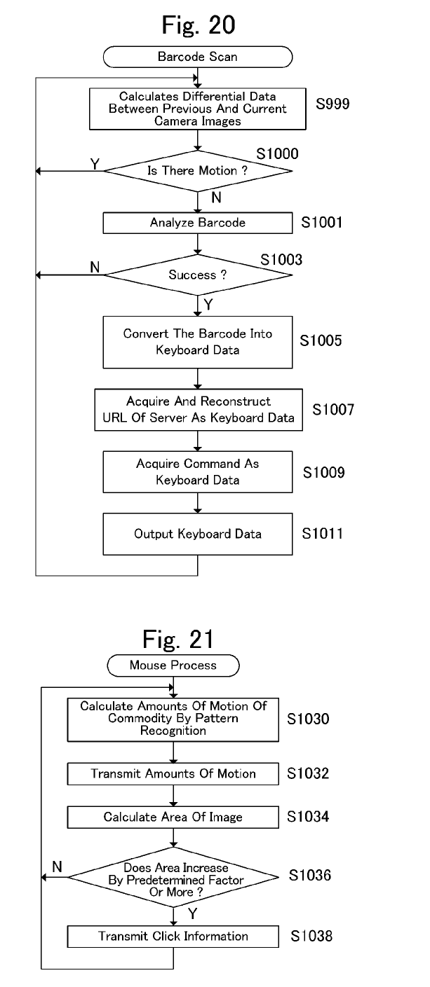

FIG. 20 is a flow chart for showing an example of the process of scanning a barcode by the MCU 192 of FIG. 19. Referring to FIG. 20, the MCU 192 calculates the differential data between the previous camera image (taken in the previous frame) and the current camera image (taken in the current frame) to acquire the differential image therebetween in step S999. In step S1000, the MCU 192 determines whether or not the commodity product being imaged has moved on the basis of the differential image. If the commodity product has moved, since the barcode cannot be scanned, the process is returned to step S999. Conversely if the commodity product has not moved, the process proceeds to step S1001. Incidentally, if the commodity product has moved, it is recognized that the user utilizes the camera unit 180 as a pointing device by moving the commodity product.

In step S1001, the MCU 192 analyzes the barcode included in the image taken by the imaging device 194, and numerically converts the barcode image to acquire barcode information. In step S1003, the MCU 192 determines whether or not the barcode has been successfully analyzed. If the barcode has not been successfully analyzed, the process is returned to step S999. Conversely if the barcode has been successfully analyzed, the process proceeds to step S1005.

In step S1005, the MCU 192 converts the barcode information which is the result of analysis into keyboard data, and stores the keyboard data in the RAM 196. In step S1007, then, the MCU 192 acquires the URL (for example, “http://www.ssd.co.jp”) of the advertisement support server 31 as keyboard data from the ROM 198, appends the barcode information (for example, “4560256580016”) and the serial number 30 (for example, “13222159”) of the camera unit 180 as keyboard data to the end of the URL, and stores it in the RAM 196 as a new URL (for example, “http://www.ssd.co.jp/?bc=4560256580016&sn=13222159”).

In step S1009, the MCU 192 acquires a command from the ROM 198 in the form of keyboard data which instructs the PC 43 to launch the browser and access the advertisement support server 31, and stores the command in the RAM 196. In step S1011, the MCU 192 outputs the keyboard data (the command and URL (server URL+barcode information+serial number) to the PC 43 through the USB controller of the I/F 202. The PC 43 launches the browser in response to this command, and transmits the barcode information and the serial number to the advertisement support server 31.

FIG. 21 is a flow chart for showing an example of processing mouse operation by the MCU 192 of FIG. 19. Referring to FIG. 21, in step S1030, the MCU 192 calculates, by pattern recognition, the amounts of motion (in the X-axis and the Y-axis) of the moving commodity product (i.e., the commodity product which is held and moved by the user in his hand) on the basis of the image as a result of imaging operation by the imaging device 194. Then, in step S1032, the MCU 192 transmits the amounts of motion to the PC 43 through the USB controller of the I/F 202. The PC 43 receives the information about the amounts of motion, and can synchronize the motion of the cursor 114 in the individual portal screen with the motion of the commodity product which is held and moved by the user in his hand.

In step S1034, the MCU 192 calculates the area of the image of the moving commodity product. Namely, when the user holds the commodity product in his hand and move it closer to the camera unit 180, the area of the image of the commodity product increases. Processing is performed in step S1034 to detect this increase in the area of the image. In step S1036, then, the MCU 192 determines whether or not the area of the image increases by a predetermined factor (exceeding one) or more in comparison with the area calculated a predetermined number of routines earlier. If the area does not increase, the process proceeds to step S1030. Conversely, if the area increases, the process proceeds to step S1038 by determining that the user moves the commodity product close to the camera unit 180. When the area of the image increases by the predetermined factor or more in comparison with the area calculated the predetermined number of routines earlier, the MCU 192 recognizes that the user has made the gesture of clicking (corresponding to mouse click) and transmits clicking information to the PC 43 through the USB controller of the I/F 202 in step S1038. The PC 43 can recognize through the reception of the click information that the click operation is performed.

Meanwhile, as has been discussed above, in the case of the application example 4, the user-friendliness can be improved by the use of the camera unit 180 as an input device to the terminal “tm”.

In other words, the user can display the individual portal screen on the monitor of the terminal “tm” only by having the camera unit 180 take an image of the barcode attached to a commodity product such that the terminal “tm” automatically transmits the barcode information to the advertisement support server 31 in response to the command from the camera unit 180, without need for cumbersome operation performed by the user (the terminal “tm” need not be manipulated). Also, the terminal “tm” performs processing required for realizing the present system in response to the command from the camera unit 180, and thereby it is possible to save the user the trouble of installing a new program in the terminal “tm” and so forth.

Furthermore, the camera unit 180 serves not only as a means for acquiring the barcode information, but also as a mouse (pointing device). Accordingly, after taking an image of the barcode attached to a commodity product for the purpose of acquiring the barcode information to be transmitted to the advertisement support server 31 by the camera unit 180, the user can manipulate the cursor 114 displayed in the individual portal screen only by moving the commodity product which faces the camera unit 180, and thereby the structure is very user-friendly.

Meanwhile, the present invention is not limited to the above embodiment, and a variety of variations may be effected without departing from the spirit and scope thereof, as described in the following modification examples.

(1) In the case of the above examples, there is no need to install dedicated software in the terminal 5 for transmitting the barcode 11 through a browser to the host computer 1, because the local barcode reader 7 is designed to output the command 29. However, it is also possible to omit the functionality of outputting the command 29 from the local barcode reader 7, by installing such dedicated software in the terminal 5. In this case, it is preferred to launch the dedicated software in response to the input of the barcode 11, and automatically transmit the barcode 11. Also, it is possible to have the local barcode reader 7 output a command to the dedicated software, which then transmits the barcode 11 to the host computer 1 in response to the command.

Furthermore, in the case of the above examples, the local barcode reader 7 is designed to output the URL 27 of the host computer 1, such that there is no need to input the URL 27 of the host computer to the terminal 5. However, it is also possible to omit the functionality of outputting the URL 27 from the local barcode reader 7 by prompting the user to input the URL 27 of the host computer 1, or by writing the above software to include the URL 27 in the terminal 5.

The local barcode reader 7 which does not output the URL 27 and the command 29 is equivalent to an ordinary barcode reader. Accordingly, an ordinarily available barcode reader can be used for the present system by installing such software in the terminal 5.

(2) While the configuration of the individual portal screen is illustratively shown in FIG. 5(b), FIG. 9 and FIG. 11(a), the link buttons are not limited to those shown in these figures. Also, the advertisement support corporation can arbitrarily determine which link buttons are default. In addition, the advertisement support corporation can also arbitrarily determine which link buttons are provided as pay services.

Furthermore, the content items displayed in the individual portal screen are not necessarily limited to link buttons. Also, it is possible that the advertisement support server 31 does not provide the individual portal screen, but returns the URL of the website associated with the commodity indicated by the received barcode to the PC 43 or the like, and directly displays this website. The information about the commodity described in this website includes all the information items, of which the advertising client 45-M wants to inform the user after and before purchasing the commodity. This is true also in the case of the information about the commodity distributed from the target of a link button in the individual portal screen.

(3) The link targets of the link buttons 102, 106, 118, 108 and 116 contained in the first individual portal screen 100 are files in the server 47 of the advertising client 45-M. However, as physically viewed, this server 47 is not necessarily a single server, but the link targets thereof may be contained in a plurality of servers. This alternative can be applied in the same manner to the case where the link targets of the link buttons contained in the first individual portal screen 130 are files in the server 47 of the advertising client 45-M. Furthermore, this is true also in the case where the link targets of the link buttons contained in the second individual portal screen 101 are files in the server 47 of the advertising client 45-M.

Likewise, the user registration function, the questionnaire function and the household account book generation function of the advertisement support server 31 can be implemented with separate servers respectively. Of course, the processes of the advertisement support server 31 can be performed by a plurality of servers as distributed processing.

Furthermore, the link targets of the buttons 126, 168 and 124 displayed in the frame 164 of the second individual portal screen 101 are files in the server 47 of the store central office 75-P. However, as physically viewed, this server 47 is not necessarily a single server, but the link targets may be contained in a plurality of servers.

(4) In the case of the above examples, while the barcode 11 is employed as the information to be transmitted to the host computer 1 and the advertisement support server 31, the present invention is not limited thereto. For example, an electronic tag (IC tag) such as RFID (Radio Frequency Identification System) can be used. However, in this case, the information encoded in the electronic tag is read by an electronic tag reader (IC tag reader) in place of the barcode reader 7. Preferably, the electronic tag reader is designed to issue the same command as the barcode reader 7, and output the URL of the host computer 1. Also, while a one-dimensional barcode which is a one-dimensional code is used in the above examples, it is possible to use a two-dimensional barcode or QR code as a two-dimensional code.

(5) As physically viewed, the host computer 1 and the advertisement support server 31 can be implemented with a single computer. Alternatively, the processes of the host computer 1 or the advertisement support server 31 can be performed by a plurality of servers as distributed processing. Of course, in the case where distributed processing is employed, the respective computers may be located in the same country, or distributed in a plurality of countries. Meanwhile, the host computer 1 and the advertisement support server 31 as referred to herein are devices which are implemented by means of hardware and/or software.

(6) In the case of the application examples 1 through 4, when receiving an instore code from the barcode reader 7 or the camera unit 180, the advertisement support server 31 can return a predetermined message (for example, a notification that no service is available) to the terminal “tm”. The instore code is a barcode which is defined by a retail seller for use only in the store. Accordingly, since the code is not necessarily unique in the whole market, it is rejected.

(7) It is also possible to use the barcode recognition feature implemented with the camera of a cellular phone in place of the barcode reader 7. This is true in the case of the recognition of QR codes. In this case, for example, software is installed in the cellular phone for transmitting the barcode to the host computer 1 and the advertisement support server 31. Also, in place of the barcode reader 7, it is possible to scan the barcode by an ordinary camera which is connected to a personal computer. In this case, software is installed in the personal computer for reading the barcode. This is true in the case of the recognition of QR codes.

(8) While the first group 251 includes the JAN code in the case of the above examples, it is possible to also include EAN (European Article Number) and/or UPC (Universal Product Code) in the first group 251.

(9) The application example 2 and the application example 3 as described above can be combined. Namely, the advertisement support server 31 performs processing by classifying the barcode as received into either the first group 251 or the second group 252. In this case, when receiving a barcode belonging to the first group 251, the advertisement support server 31 provides different content items between the individual portal screen displayed on the PC 43 of the personal residence 41-N from which the user accesses the advertisement support server 31 and the individual portal screen displayed on the computer 37 of the store 35-K from which the user accesses the advertisement support server 31, even though the same barcode is scanned.

(10) In the case of the above application example 2, it is determined in which of the store 35-K and the personal residence 41-N the terminal “tm” is installed, on the basis of the URL transmitted from this terminal “tm” (step S400 of FIG. 12). However, any other appropriate method can be employed as long as the advertisement support server 31 can determine the location where the terminal “tm” is installed, i.e., the location from which the barcode is transmitted.

(11) In the case of the above application example 3, the received barcode is classified into either the first group 251 or the second group 252 with reference to the number of digits of the received barcode (step S430 of FIG. 17). However, any other appropriate method can be employed as long as it is possible to determine the belonging group of the barcode. For example, the barcode can be classified by giving the advertisement support server 31 the information indicative of the belonging group of the barcode transmitted from the barcode reader 7 or the terminal “tm” together with the barcode itself.

(12) While the advertisement support server 31 runs the control programs 174-1 to 174-q shown in FIG. 16, it is also possible to run these programs by separate computers respectively. In this case, the communication control unit 212 transmits the barcode 2520 belonging to the second group 252 to the computer responsible for running the control program 174-Q corresponding to this barcode 2520, and this computer provides the corresponding content to the terminal “tm”.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

Also, the term “unit” as used herein does not always refer to a physical device but can also refer to software for implementing the functions of this unit. Furthermore, the functions of one unit may be implemented by two or more physical devices. Conversely, the functions of two or more units may be implemented by one physical device.

1. A remote code leader system comprising:
a plurality of unspecified local code leaders each of which is capable of reading a code and connected with a communication terminal which is provided corresponding to the each local code leader and connectable with the Internet; and
a host computer operable to receive a plurality of the codes transmitted from the plurality of said local code leaders respectively,
wherein each of said local code leaders includes a transmission unit which transmits the code as read to said host computer through the communication terminal corresponding thereto and the Internet, and
wherein said host computer includes a processing unit which performs a predetermined process by the use of the code as transmitted from said local code leader.

2. A remote code leader system comprising:
a plurality of local code leaders each of which is capable of reading a code and connected with a communication terminal which is provided corresponding to the each local code leader and connectable with the Internet; and
a host computer operable to receive a plurality of the codes transmitted from the plurality of said local code leaders respectively,
wherein each of said local code leaders includes a transmission unit which transmits the code as read to said host computer through the communication terminal corresponding thereto and the Internet,
wherein said host computer includes a processing unit which performs a predetermined process by the use of the code as transmitted from said local code leader, and
wherein the code is transmitted to said host computer by the communication terminal through the Internet in response to transmission of the code from the transmission unit.

3. The remote code leader system as claimed in claim 1 wherein the processing unit transmits, to the communication terminal, information for showing a display on the communication terminal in accordance with the predetermined process which is performed.

4. A remote code leader system comprising:
a plurality of local code leaders each of which is capable of reading a code and connected with a communication terminal which is provided corresponding to the each local code leader and connectable with the Internet; and
a host computer operable to receive a plurality of the codes transmitted from the plurality of said local code leaders respectively,
wherein each of said local code leaders includes a transmission unit which transmits the code as read to said host computer through the communication terminal corresponding thereto and the Internet,
said host computer comprising:
a receiver unit operable to receive the codes which are transmitted from said local code leaders;
a classification unit operable to classify each of the received codes into one of a plurality of groups; and
a processing unit operable to perform, by the use of each of the received codes, a process corresponding to the group to which the each of the received codes belongs.

5. The remote code leader system as claimed in claim 1 wherein the transmission unit outputs, to said communication terminal, the code, address information of said host computer and a command for instructing said communication terminal to transmit the code to said host computer.

6-68. (canceled)
